(19) United States
(12) Patent Application Publication
(10) Pub. No.: US 2004/0139441 A1
(43) Pub. Date: Jul. 15, 2004

(54) Processor, arithmetic operation processing method, and priority determination method

(75) Inventors: Satoshi Kaburaki, Tokyo (JP); Yukimasa Miyamoto, Kanagawa-Ken (JP); Shinichi Kanno, Kanagawa-Ken (JP); Masaya Tarui, Kanagawa-Ken (JP); Taku Ooneda, Kanagawa-Ken (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/752,703

(22) Filed: Jan. 8, 2004

(30) Foreign Application Priority Data
Jan. 9, 2003 (JP) 2003-3428
Mar. 24, 2003 (JP) 2003-79478

(51) Int. Cl. G06F 9/50

(52) U.S. Cl. 718/107

(57) ABSTRACT

A processor which performs data processings including a plurality of execution units, comprising a storage which stores data used for processings of the execution units and processing results by the execution units, by each of the execution units, a data processing part configured to acquire data of the execution units from said storage to perform the processings, and configured to output the processing results in said storage, an execution unit judgement part configured to determine whether or not said storage holds data used for the processings of a certain execution unit, and whether or not said storage has a vacant region capable of storing the processing result of the certain execution unit, and an execution unit determination part which determines an execution unit to be processed next among said plurality of execution units, based on a result judged by said execution unit judgement part.

### CROSS REFERENCE TO RELATED APPLICATIONS

This application claims benefit of priority under 35USC § 119 to Japanese Patent Applications No. 2003-3428, filed on Jan. 9, 2003 and No. 2003-79478, filed on Mar. 24, 2003, the entire contents of which are incorporated by reference herein.

### BACKGROUND OF THE INVENTION

1. Field of the Invention

The present invention relates to a processor for time-sharing a data processing to at least one or more time-shared data processings each acting as an execution unit and executing the data processings in each execution unit.

2. Related Art

When a processor executes a plurality of threads by time-sharing, the threads are typically switched using software such as an operation system.

The operation system detects at every predetermined time interval whether or not the respective threads has become executable. Whether or not the threads has become executable is determined based on whether or not data to be processing is prepared.

While the operation system executes the above determination processing, the execution of the threads must be suspended. While the execution of the threads is suspended, the contents of a general-purpose register, a stack pointer (SP), a program counter (PC), and the like are saved in an external main memory and the like of the processor. The various types of the saved information are managed by the operation system together with thread identification information (thread ID).

The operation system has a scheduler for determining a thread that is actually executed from executable threads according to, for example, a round robin system and the like.

The operation system obtains the various types of information, which have been saved in the main memory and the like, with respect to the thread whose execution is determined by the scheduler, restores the contents of the general-purpose register, the stack pointer (SP), the program counter (PC), and the like to respective registers from the main memory in which they are saved, and then starts to execute the thread.

There has been proposed a system for realizing parallel processing of real time data using a plurality of data processing units composed of hardware (refer to JP. 2000-509528). However, the system is disadvantageous in that the arrangement itself becomes complex because a plurality of data processing cores for executing the parallel processing as well as their arbitration mechanism must be provided.

When the threads are switched using the software such as the operation system, and the like, a processor having a performance higher than that necessary to execute intrinsic thread processing must be prepared because there is an overhead due to the operation of the operation system itself.

Further, since it is time-consuming to switch the threads by the operation system, it is difficult to construct a real time system.

Further, since the operation system determines whether or not the threads can be executed at only every predetermined time interval, it determines that the threads can be executed after they have become executable actually, and thus it may take time until they are actually executed. Accordingly, the responsiveness of the processor is bad, which makes the real time system construction more difficult.

When it is determined that the threads can be started based on whether or not data to be processed is prepared, the data may not be stored in a region in which a result of processing is stored, and in this case the data is lost.

In contrast, when it is intended to realize real-time processing by using data processing units many of which are formed of hardware, there is a tendency that an arrangement is made complex and expensive heretofore.

### SUMMARY OF THE INVENTION

An object of the present invention, which was made in view of the above problems, is to provide a processor that can effectively execute a plurality of threads in real time, an arithmetic operation processing method, and a priority determination method.

A processor according to one embodiment of the present invention which performs data processings including a plurality of execution units, comprising:

a storage which stores data used for processings of the execution units and processing results by the execution units, by each of the execution units;

a data processing part configured to acquire data of the execution units from said storage to perform the processings, and configured to output the processing results in said storage;

an execution unit judgement part configured to determine whether or not said storage holds data used for the processings of a certain execution unit, and whether or not said storage has a vacant region capable of storing the processing result of the certain execution unit; and

an execution unit determination part which determines an execution unit to be processed next among said plurality of execution units, based on a result judged by said execution unit judgement part.

Furthermore, an arithmetic operation processing method according to one embodiment of the present invention, comprising:

executing processings by each of execution units which executes time-sharing processings for a certain data processing;

storing data used by processing for the execution unit prescribed in advance into a first storage;

storing the processing result obtained by processing of the corresponding execution unit by using data acquired from said first storage into a second storage, and storing data used by processings of an other execution unit using the stored processing result by the corresponding execution unit;

judging whether or not said first storage holds data using to the processings of the execution unit, and whether or not said second storage has a vacant region to store the processing result of the execution unit; and

determining the execution unit to be started up next among said plurality of execution units.

Furthermore, a processor according to one embodiment of the present invention, comprising:

a data processing part configured to execute processings by each of execution units which execute time-sharing processings for a certain data processing;

a plurality of storages which stores data used by the execution unit to be executed by said data processing part, or an execution result of data used by the execution unit to be executed by said data processing part; and

a priority determination part configured to determine priorities of the execution units using data stored in the storages based on the amount of data stored in said plurality of storages.

Furthermore, a priority determination method according to one embodiment of the present invention, comprising:

executing processing by each of execution units which executes time-sharing processings for a certain data processing;

storing data used by an execution unit to be executed or an execution result by the execution unit, into a plurality of storages; and

determining a priority of the execution unit using data stored in said storages based on the data amount stored in said plurality storages.

### BRIEF DESCRIPTION OF THE DRAWINGS

FIG. 1 is a view showing the processing contents of a software radio device.

FIG. 2 is a view showing the schematic processing procedure of the processor.

FIG. 3 is a block diagram showing the schematic arrangement of a first embodiment of a processor according to the present invention.

FIG. 4 is a block diagram showing the schematic arrangement of the second embodiment of a processor according to the present invention.

FIG. 5 is a block diagram showing the detailed arrangements of an executing thread determination unit and the thread ID/priority supply unit.

FIG. 6 is a flowchart showing the processing procedure of the executing thread determination unit of FIG. 5.

FIG. 7 is a block diagram showing the schematic arrangement of the third embodiment of a processor according to the present invention.

FIG. 8 is a time chart explaining the operation of the fourth embodiment of a processor according to the present invention.

FIG. 9 is a block diagram showing the schematic arrangement of the fifth embodiment of a processor according to the present invention.

FIG. 10 is a block diagram of a processor showing a modified example of FIG. 9.

FIG. 11 is a view showing data structure of the external register set storing unit.

FIG. 12 is a block diagram showing the schematic arrangement of the sixth embodiment of a processor according to the present invention.

FIG. 13 is a view showing the data arrangement of the external register set storage.

FIG. 14 is a flowchart showing the processing procedure of the hit determination unit.

FIG. 15 is a block diagram showing the schematic arrangement of the seventh embodiment of a processor according to the present invention.

FIG. 16 is a flowchart showing the processing procedure of the retreating register set determination unit.

FIG. 17 is a block diagram showing the schematic arrangement of the eighth embodiment of a processor according to the present invention.

FIG. 18 is a view showing data structure of the register set ID/ thread ID corresponding unit according to the eighth embodiment.

FIG. 19 is a flowchart showing processing procedures of the hit determination unit in the case of receiving the miss-time transfer hit determination request.

FIG. 20 is a flowchart showing processing procedures of the hit determination unit in the case of receiving the hit determination request.

FIG. 21 is a view explaining the execution form of the tasks in the case where the flag set in the register set ID/task ID corresponding unit exists.

FIG. 22 is a view showing the data structure of the register sets of the ninth embodiment.

FIG. 23 is a flowchart showing processing procedures in the case where there is a request to rewrite the registers.

FIG. 24 is a flowchart showing processing procedures in the case where there is a transfer request for the external register set storage to the register set group.

FIG. 25 is a processing procedure executed by a register set transfer unit when the register set group requests the external register set storage to transfer the contents of the register set.

FIG. 26 is a view showing the data structure of the external register set storage.

FIG. 27 is a flowchart showing a processing for initializing the valid flags.

FIG. 28 is a flowchart of a processing for setting the valid flags.

FIG. 29 is a flowchart showing a processing procedure, which is executed by the external storage controller when the external register set storage 32 requests a transfer to the register set group.

FIG. 30 is a view showing the data structure of the external register set storage 32 of the eleventh embodiment.

FIG. 31 is a flowchart showing the processing procedure of an external storage controller when the external register set storage requests a register set group to transfer the contents of a register set.

FIG. 32 is a flowchart showing the processing procedure executed by an external storage controller when a register set transfer unit requests the external register set storage to transfer the contents of a register.

FIG. 33 is a flowchart showing the processing procedure executed by the external storage controller when the processing of the thread has been finished.

FIG. 34 is an example of the block diagram of a processor in the twelfth embodiment.

FIG. 35 is a view explaining the outline of the thread processing executed by the processor of the embodiment.

FIG. 36 is a graph showing an example of a method by which the execution controller of the embodiment determines the execution priority of a thread with respect to the amount of data accumulated by the input side FIFO memory for the thread.

FIG. 37 is a view showing an example of a method of determining the priority of a thread with respect to the amount of data accumulated by an output side FIFO memory in the processor of the embodiment.

FIG. 38 is a flowchart showing an example for determining a thread that is executed next by the processor of the embodiment.

FIG. 39 is a graph showing an example of a method of determining the priority of a thread with respect to the amount of data accumulated by an input side FIFO memory in the processor of the embodiment.

FIG. 40 shows an example of a method of determining the priority of a thread with respect to the amount of data accumulated by an output side FIFO memory in the processor of the embodiment.

### DESCRIPTION OF THE PREFERRED EMBODIMENTS

A processor, an arithmetic operation processing method, and a priority determination method according to the present invention will be specifically explained below with reference to the drawings.

(First Embodiment)

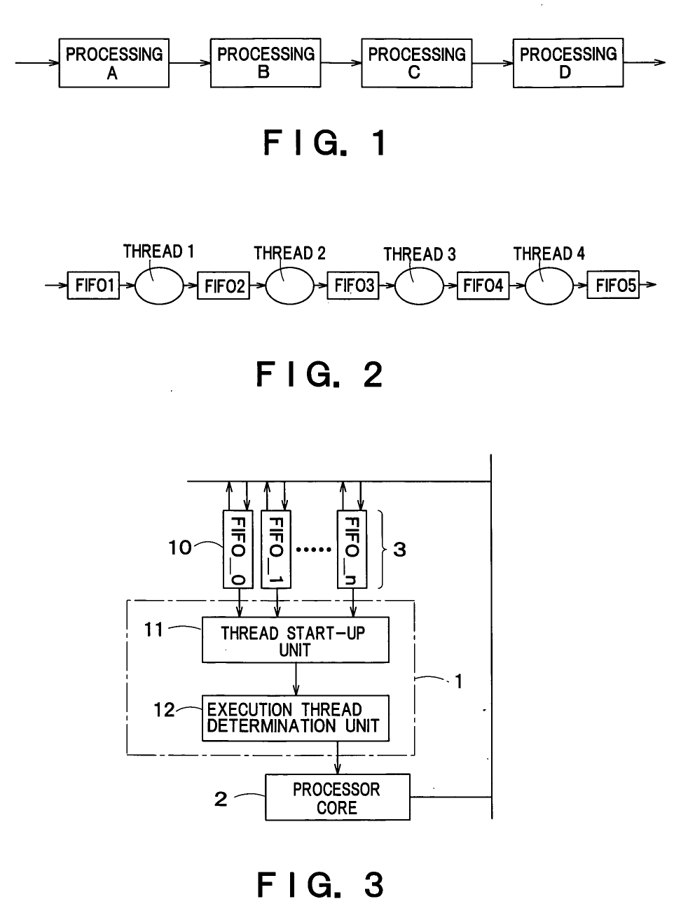

There is an increasing requirement for executing a plurality of threads in real time by time-sharing. For example, FIG. 1 is a view showing the processing contents of a software radio device. In the software radio device of FIG. 1, processings A to D are continuously executed. For example, the processing B executes a predetermined arithmetic operation processing using the output from the processing A as an input, and delivers a result of a predetermined processing executed thereby to the processing C.

In FIG. 1, the amounts of output data from the respective processings do not always correspond to an amount of data necessary to start a next processing. Further, the respective processings have various amounts of processing depending on the contents to be processed. Further, since data is delivered at different timings between the respective processings, the respective processings must be executed after they are synchronized with each other.

To effectively realize the processings in FIG. 1, each of the processings is often created as at least one thread. The respective threads are realized by software or hardware. The term “thread” used here means a processing unit or execution thereof, which is to be executed by a processor, is allocated at each of a plurality of time intervals. Since the processor of the embodiment is of a data-flow type, one processing is completed by sequentially processing a plurality of divided threads with respect to one processing data. Since the threads are processed in parallel with each other, a plurality of processing data can be subjected to data-flow type processing in asynchronism with each other. A purpose of arranging one processing as the threads as described above is mainly to realize multi-thread processing such as a real time operation system.

In this embodiment, First-In, First-Out (FIFO) buffers are inserted between the threads so that they need not be in strict synchronism with each other. Although FIFO generally means a data storing method, in the embodiments shown below, it means a system for taking out stored data in the sequence of the data stored in the past (First-In, First-Out system), that is, it means a FIFO type memory unit (buffer). Namely, the data stored most recently is taken out finally, and a data structure called cue, for example, is employed in a memory unit using this system. In this case, the schematic processing procedure of the processor is as shown in FIG. 2.

In FIG. 2, a FIFO memory 1 supplies data input to a thread 1, and a FIFO memory 2 receives the data output from the thread 1 as well as supplies data input to a thread 2.

Although each of the threads in FIG. 2 is provided with one FIFO memory on the input side and the other FIFO memory on the output side, it may be provided with a plurality of FIFO memories.

Although the software radio device may be realized by the arrangement shown in FIG. 2, the realization of it is difficult because a large amount of processing must be executed to synchronize the respective threads with each other, and thus even if the FIFO memory is used, the overhead of the processor is increased to synchronize the threads with each other.

When attention is paid to the start-up conditions of the respective threads, they need not be started when there is no input data. Further, when the FIFO memories provided on the output sides of the respective threads have no vacant regions for storing results of processing of the threads, the threads also need not be started because there is a possibility that results of processing are lost.

Thus, in the respective embodiments of the present invention explained below, the state of the data stored in the FIFO memories is monitored, and the threads are started only when there is data to be supplied to the respective threads as well as the FIFO memories provided on output sides of the threads have a vacant region.

FIG. 3 is a block diagram showing the schematic arrangement of a first embodiment of a processor according to the present invention. A processor of FIG. 3 includes an execution controller 1 for controlling the execution of the threads, a processor core 2 for executing the threads, a memory unit 3 for storing the data used to execute the threads and the results of execution of the threads, and a bus 4 connected to the processor core 2 and the memory unit 3.

The execution controller 1 includes a thread start-up unit 11 for determining whether or not a plurality of the threads can be started, respectively and an executing thread determination unit 12 for determining a thread to be started based on a result of determination of the thread start-up unit 11. The processor core 2 executes a thread whose execution is determined by the executing thread determination unit 12.

A storage 3 including a plurality of FIFO memories 10 is connected to the thread start-up unit 11. FIG. 3 shows an example in which the FIFO memories 10 have n sets of FIFO memories FIFO_{—}0 to FIFO_n. The respective FIFO memories 10 correspond to the FIFO 1 and the like of FIG. 2, and the thread start-up unit 11 decides the thread to be executed next. More specifically, the thread start-up unit 11 holds the data that is output from a FIFO memory 10 (for example, FIFO_{—}0) and supplied to a thread, and confirms whether or not other FIFO memory 10 (for example, FIFO_{—}1), to which a result of processing of the thread is to be stored, has a vacant region. As long as the FIFO memory 10 (for example, FIFO_{—}0) has the output data to be supplied to the thread and the other FIFO memory 10 (for example, FIFO_{—}1) has the vacant region in which the result of processing of the thread is to be stored, it is determined that the thread must be started.

When a plurality of threads can be started, the executing thread determination unit 12 selects any one of the threads. For example, a thread having a smallest thread ID is executed to, for example, identify the respective threads.

The processor core 2 includes, for example, a command capturing unit, a command interpreting unit, a command executing unit, a result of executed command storing unit for storing a result of an executed command, and a command executing state storing unit for storing a command executing state.

As described above, in the first embodiment, FIFO memories hold the data to be supplied to threads, the thread start-up unit 11 determines whether or not other FIFO memories 10, which must store a result of execution of the threads, have a vacant region, and the executing thread determination unit 12 determines a thread to be started based on the result of determination of the thread start-up unit 11. Accordingly, the threads can be scheduled without an operation system and thus are not affected by the overhead of the operation system, thereby the threads can be processed in real time.

(Second Embodiment)

A second embodiment sets priorities to a plurality of threads and executes the threads according to the priorities.

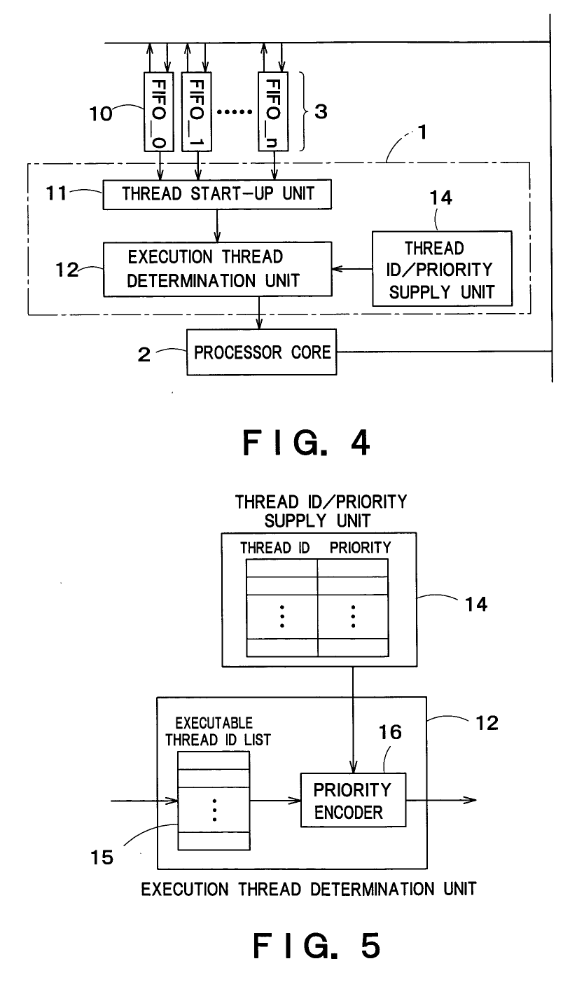

FIG. 4 is a block diagram showing the schematic arrangement of the second embodiment of a processor according to the present invention. An execution controller 1 in the processor of FIG. 4 includes a thread ID/priority supply unit 14 for supplying the thread ID and the priority of each of a plurality of threads in addition to the arrangement of FIG. 3.

FIG. 5 is a block diagram showing the detailed arrangements of an executing thread determination unit 12 and the thread ID/priority supply unit 14. As shown in FIG. 5, the thread ID/priority supply unit 14 stores the corresponding relationship between the thread IDs and the priorities of the respective threads. The executing thread determination unit 12 includes an executable thread ID list 15, in which a list of executable threads notified from a thread start-up unit 11 is registered, and a priority encoder 16 for determining a thread to be started.

The priority encoder 16 obtains the priorities of the threads registered in the thread ID list 15 from the thread ID/priority supply unit 14 and determines, for example, a thread having the highest priority as a thread to be started.

Although a method of setting the priorities supplied by the thread ID/priority supply unit 14 is not particularly limited, when, for example, a new thread is created, the priority of the thread may be set or the priority thereof may be changed afterward.

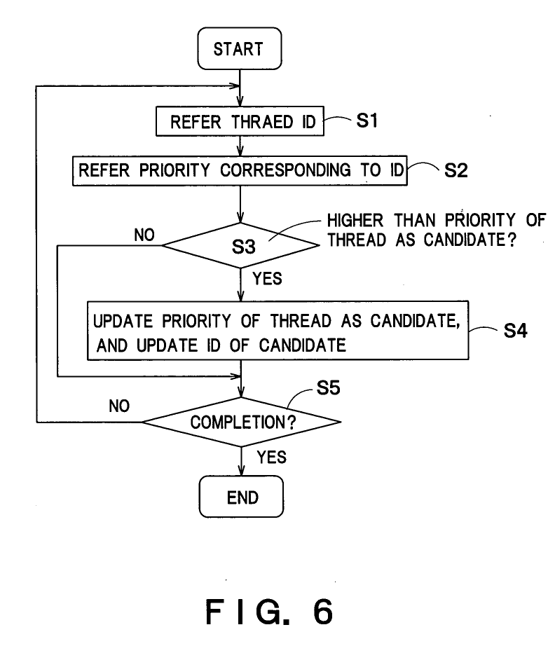

FIG. 6 is a flowchart showing the processing procedure of the executing thread determination unit 12 of FIG. 5. First, reference is made to the thread IDs of the threads registered in the executable thread ID list 15 (step S1), and the priorities corresponding to the thread IDs are obtained from the thread ID/priority supply unit 14 (step S2).

Next, it is determined whether or not the priorities obtained at step S2 are higher than the priority of a thread as a candidate to be started (step S3), and when the former priorities are higher than the latter priority, the threads having the thread IDs referred to at step S1 are set as candidates to be started (step S4).

When the processing at step S4 is finished or when it is determined at step S3 that the priorities obtained at step S2 are not higher than the priority of the thread as the candidate to be started, it is determined whether or not threads whose priorities are not yet compared still remain in the executable thread ID list 15 (step S5), and when they still remain, the processing at step S1 and the subsequent steps are repeated, whereas when they do not remain, the processing procedure is finished.

As described above, in the second embodiment, since the priorities of the threads are determined previously, when a plurality of threads are selected as candidates to be started, a thread having a higher priority can be executed preferentially, thereby the processings can be effectively executed. Further, a thread to be started can be promptly selected.

(Third Embodiment)

A third embodiment can dynamically change priorities.

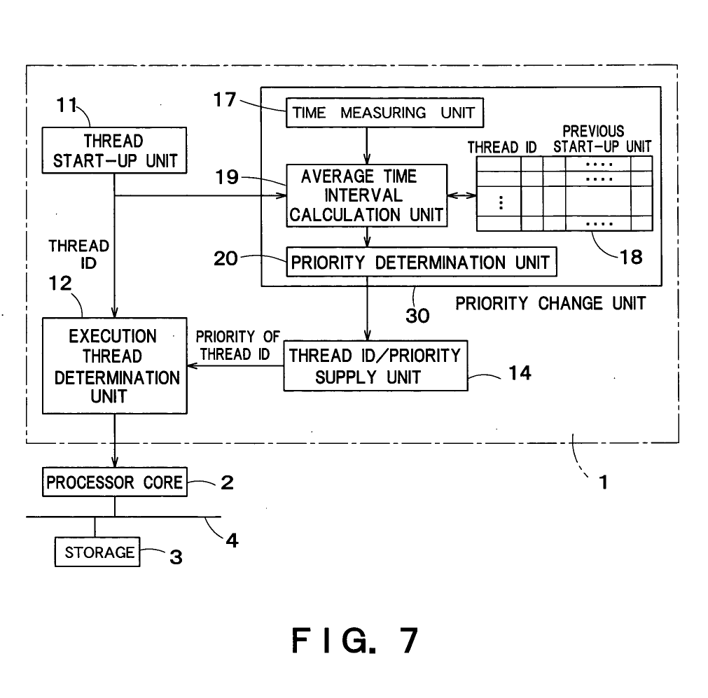

FIG. 7 is a block diagram showing the schematic arrangement of the third embodiment of a processor according to the present invention. The processor of FIG. 7 includes a priority change unit 30 for dynamically changing the priorities of threads in addition to the arrangement of FIG. 4.

The priority change unit 30 includes a time measuring unit 17 for measuring an executing time of each thread, a starting-up time table 18, in which the corresponding relationship between the thread IDs of respective threads and past starting-up times is registered, an average time interval calculation unit 19 for calculating the average starting-up interval of the respective threads, and a priority determination unit 20 for determining the priorities of the respective threads based on a result of calculation of the average time interval calculation unit 19.

A smaller value obtained as a result of calculation of the average time interval calculation unit 19 shows that a thread is more frequently started. Accordingly, the priority determination unit 20 sets a higher priority to, for example, a thread having a smaller value as a result of calculation of the average time interval calculation unit 19.

More specifically, the average time interval calculation unit 19 calculates the intervals of data input to respective FIFO memories 10, and the priority determination unit 20 determines the priorities of the threads such that a thread corresponding to a FIFO memory 10, to which data having shorter input intervals is input, has a higher priority. Otherwise, the average time interval calculation unit 19 may calculate the execution intervals of the respective threads notified from a processor core 2, and the priority determination unit 20 may determine the priorities of the threads such that a thread having shorter execution intervals has a higher priority. Otherwise, the average time interval calculation unit 19 may monitor the vacant regions of the respective FIFO memories 10 that supply data to the respective threads, and the priority determination unit 20 may determine the priorities of the threads such that a thread corresponding to a FIFO memory 10 having a smaller vacant region has a higher priority. Otherwise , the average time interval calculation unit 19 may calculate the intervals at which data is output from the respective threads to the respective FIFO memories 10, and the priority determination unit 20 may determine the priorities of the threads such that a thread corresponding to a FIFO memory 10, to which data is input at shorter intervals, has a higher priority.

As described above, in the third embodiment, since the priorities of the respective threads can be dynamically changed, the threads can be scheduled with reference to the history executed in the past.

(Fourth Embodiment)

In a fourth embodiment, when a thread, which has a priority higher than that of a thread being executed, is ready to execute, the thread being executed is suspended, and the thread having the higher priority is started.

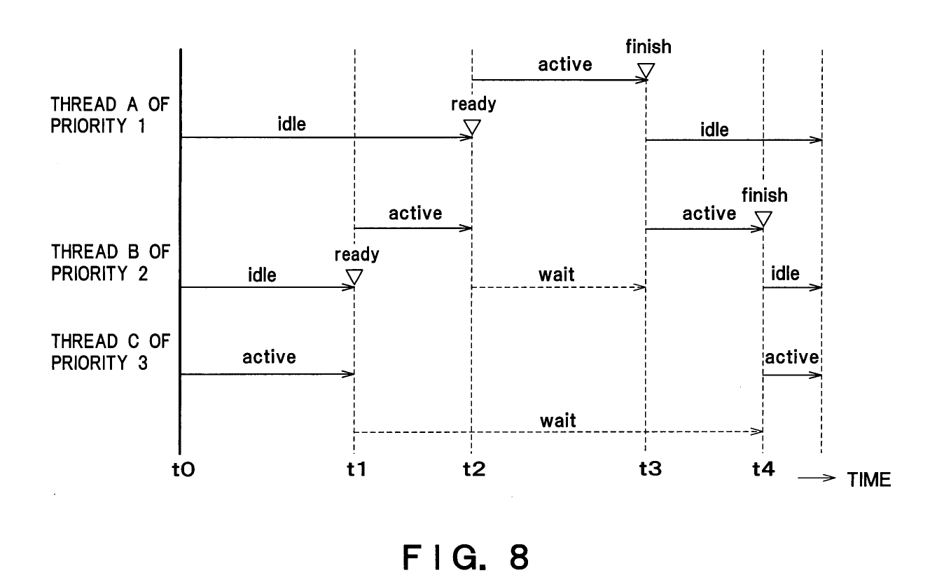

The block arrangement of the fourth embodiment is the same as those shown in FIGS. 4 and 7. FIG. 8 is a time chart explaining the operation of the fourth embodiment of a processor according to the present invention. FIG. 8 shows an example having three threads A, B, C, in which the thread A has the highest priority, the thread B has the intermediate priority, and the thread C has the lowest priority.

In FIG. 8, first, the thread C starts at a time t0. Thereafter, the startup of the thread B is prepared at a time t1. With this preparation, an executing thread determination unit 12 suspends the execution of the thread C and starts the operation of the thread B in place of the thread C.

Thereafter, the start-up of the thread A is prepared at a time t2. With the preparation, the executing thread determination unit 12 suspends the execution of the thread B and starts the operation of the thread A in place of the thread B.

When the execution of the thread A is finished at a time t3, the execution of the thread B having the intermediate priority is resumed, and when the execution of the thread B is finished at a time t4, the execution of the thread C having the lowest priority is started.

As described above, in the fourth embodiment, when the start-up of a thread having a priority higher than that of a thread being executed is prepared, the processing of the thread being executed is suspended and the execution of the thread having the higher priority is started. Accordingly, an important thread can be preferentially processed at all times, thereby the processing capability of the processor can be improved in its entirety.

(Fifth Embodiment)

Fifth to eleventh embodiments that will be explained below relate to arrangements for promptly switching a thread being executed.

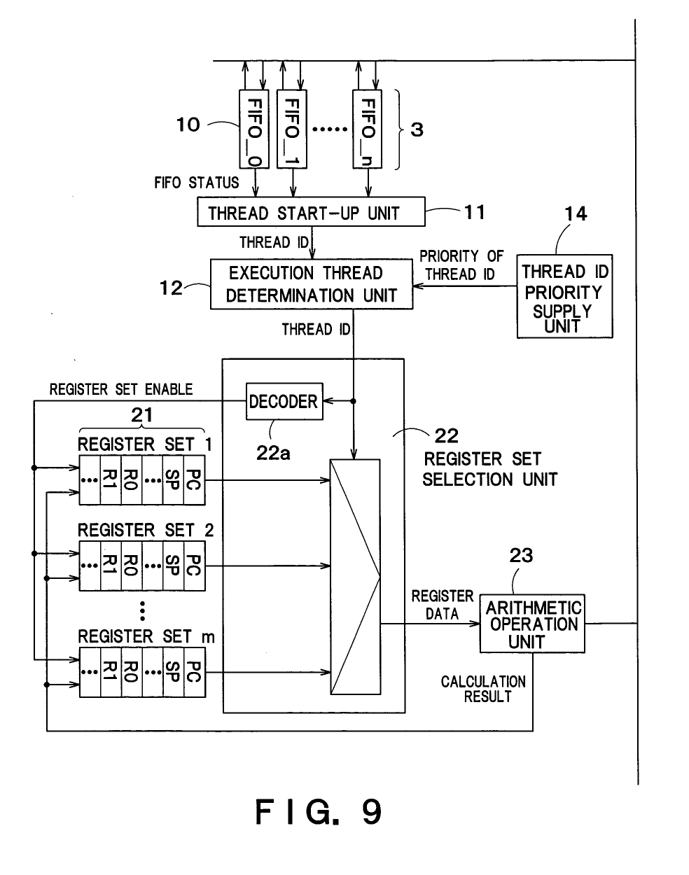

FIG. 9 is a block diagram showing the schematic arrangement of the fifth embodiment of a processor according to the present invention. The processor of FIG. 9 includes a thread start-up unit 11, an executing thread determination unit 12, and a thread ID/priority supply unit 14 which are the same as those of FIG. 4. In addition to the above units, the processor includes a register set group 21 composed of a plurality of register sets, a register set selection unit 22 for selecting any one of the registers from the register set group 21, and an arithmetic operation unit 23 for executing arithmetic operation processing using a selected register set. These register sets, the register set selection unit 22, and the arithmetic operation unit 23 constitute a processor core 2.

The register set selection unit 22 has a decoder 22a provided therein which selects one register set from the register set group 21. The decoder 22a outputs a signal for selecting a register set corresponding to a thread ID from the executing thread determination unit 12.

Each of the respective register sets is composed of at least one register that includes all the information inherent to respective threads. The registers constituting the register set are composed of various types of a device depending on the architecture of the processor and are composed of, for example, program counters (pc), stack pointers (sp), general purpose registers (R0, R1, . . . ), and the like. In this specification, the total number of the registers provided in one register set is shown by r (r: integer not less than 1).

The total number of the register sets is m (m: integer) which is not less than the number n of threads that can be executed by time-sharing. The respective register sets are identified by inherent identification numbers (register set IDs).

A thread being executed uses one register set. When each thread uses a different type of a register, a dedicated register set may be provided with each thread. The type of the registers constituting the register sets may be determined when the processor is designed, or the type of the registers constituting the register sets may be changed in response to a program command afterward.

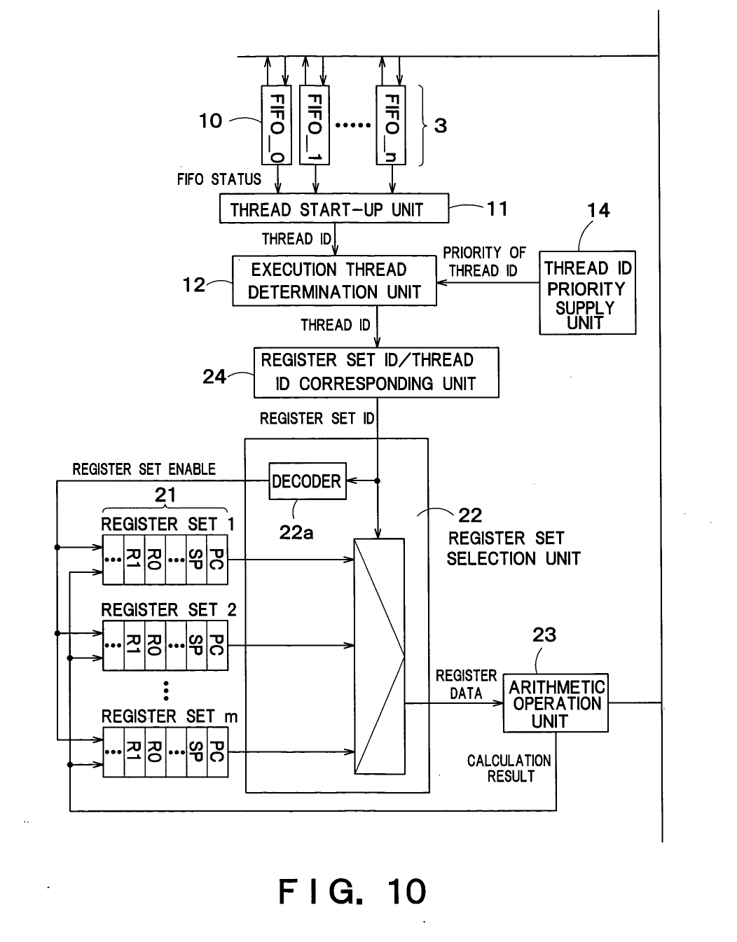

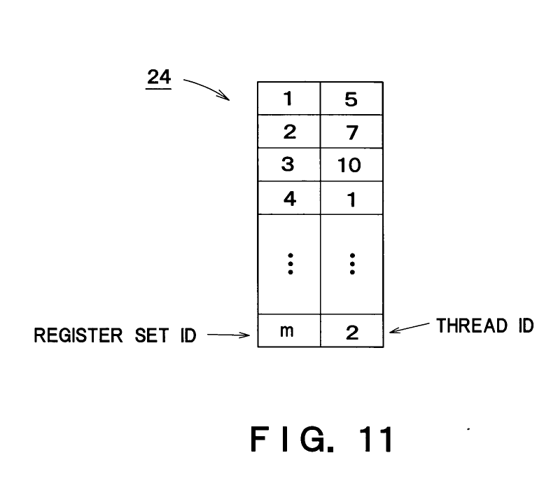

When each thread uses a different type of a register, a register set ID/thread ID corresponding unit 24, in which the corresponding relationship between thread IDs and register set IDs are registered as shown in FIG. 10, may be provided as necessary, and a register set corresponding to each thread may be determined with reference to a table showing the corresponding relationship as shown in FIG. 11.

More specifically, the register set ID/thread ID corresponding unit 24 is composed of the table shown in FIG. 11. The table of the FIG. 11 may be created when the processor is designed and the contents thereof cannot be changed thereafter or may be changed in response to a command after the processor is started.

When the executing thread determination unit 12 shown in FIGS. 9 and 10 switches a thread to another thread, the thread ID of the another thread having been switched is notified from the executing thread determination unit 12 to the register set selection unit 22. The register set selection unit 22 obtains a register set ID corresponding the switched thread using the table of FIG. 11, and the like and supplies the value of the register set, which corresponds to the register ID, to the arithmetic operation unit 23. The arithmetic operation unit 23 sets the value of the register set selected by the register set selection unit 22 to the respective registers, executes an arithmetic operation processing, and stores a result of the arithmetic operation processing in the register set selected by the register set selection unit 22.

As described above, in the fifth embodiment, when a thread is switched, a register set is also switched. Accordingly, when the thread is switched, a processing preparation time can be reduced, thereby the threads can be switched at a high speed. Further, the processing of a thread, which is suspended once, can be resumed promptly by simply reading the value a register set before the processing is resumed.

(Sixth Embodiment)

A sixth embodiment retreats at least a part of the register sets of a register set group 21 to the outside.

FIG. 12 is a block diagram showing the schematic arrangement of the sixth embodiment of a processor according to the present invention. The processor of FIG. 12 includes a hit determination unit 31, an external register set storage 32, an external storage controller 33, and a register set transfer unit 34 in addition to the arrangement of FIG. 10.

The number of the register sets of the register set group 21 may be smaller than, equal to, or larger than the number n of threads executed by time-sharing.

The hit determination unit 31 determines whether or not the register set of a thread to be executed is registered in a register set ID/thread ID corresponding unit 24. The register set transfer unit 34 transfers the contents of at least a part of the register sets in the register set group 21 to the external register set storage 32, and transfers the contents of the register sets read from the external register set storage 32 to the register set group 21. The external register set storage 32 stores the contents of at least a part of the register sets in the register set group 21.

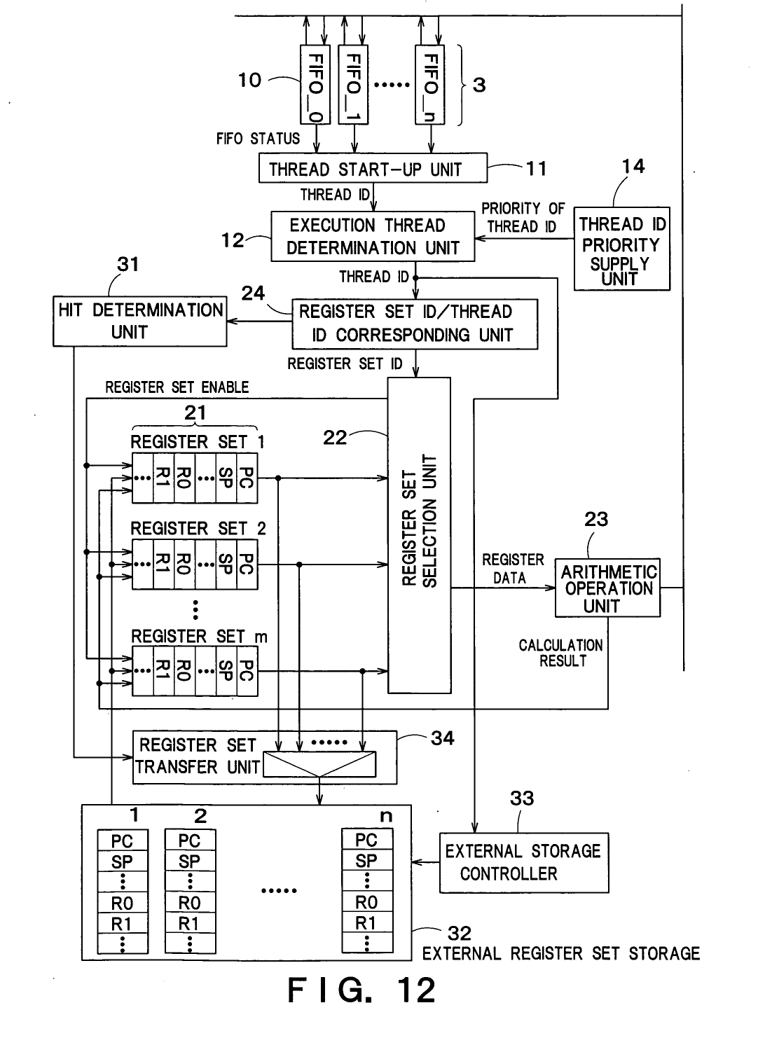

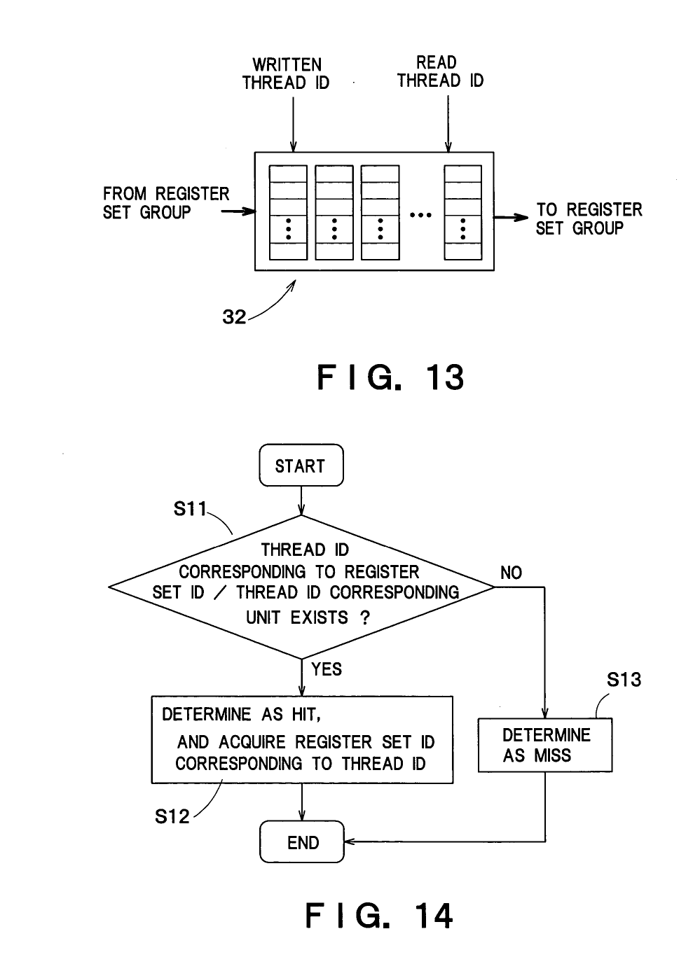

FIG. 13 is a view showing the data arrangement of the external register set storage 32. The external register set storage 32 can store the contents of arbitrary register sets included in the register set group 21 and further can transfer the stored contents of the register sets to the register set group 21. The respective register sets whose contents have been stored in the external register set storage 32 are managed by thread IDs, and when the contents, which have been stored once, of the register sets are called, the thread IDs thereof are designated.

As described above, the external register set storage 32 can temporarily retreat the contents of at least a part of the register sets in the register set group 21 and can transfer them to the register set group 21 when necessary.

The external register set storage 32 may be composed of dedicated hardware or may use a part of a memory region previously formed in a main memory and the like.

FIG. 14 is a flowchart showing the processing procedure of the hit determination unit 31. First, it is determined whether or not a register set ID, which corresponds to a thread ID showing a thread to be executed, is registered in the register set ID/thread ID corresponding unit 24 (step S11). When the register set ID is registered, it is determined that the register set ID is hit, and a register set ID corresponding to the thread ID is obtained (step S12). In this case, a thread is switched by the same procedure as that of FIG. 5.

In contrast, when the register set ID is not registered, it is determined that the register set ID is missed (step S13), and a register set corresponding to the register set ID is called from the external register set storage 32 and it is replaced with a part of the register sets of the register set group 21.

More specifically, first, the contents of at least a part of the register sets in the register set group 21 are transferred to the external register set storage 32 through the register set transfer unit 34. At the same time, the contents of the register set, which is used by a thread to be executed, are read out from the external register set storage 32 and transferred to the register set group 21 through the register set transfer unit 34.

As described above, in the sixth embodiment, the contents of at least a part of the register sets in the register set group 21 are retreated to the external register set storage 32 and returned from the external register set storage 32 when necessary. Accordingly, threads more than the total number of the register sets in the register set group 21 can be processed. As a result, the number of the register sets in the register set group 21 can be reduced, thereby the size of the processor can be reduced.

(Seventh Embodiment)

In a seventh embodiment, a register set to be retreated when a register set ID is not hit in a hit determination unit 31 is previously designated.

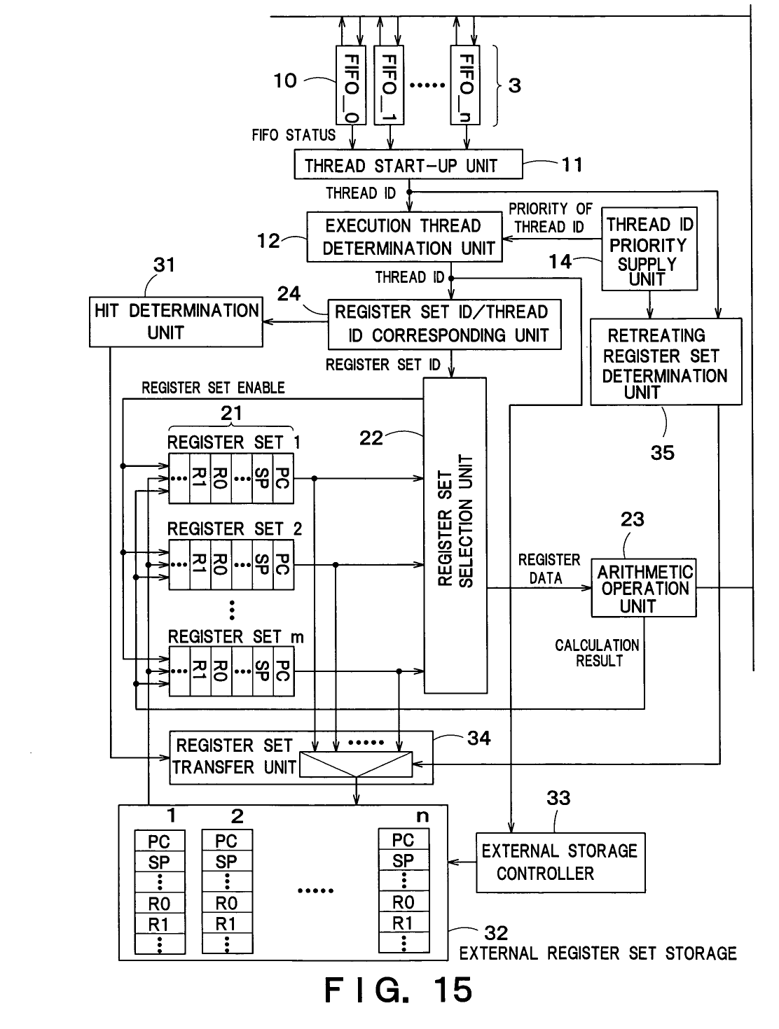

FIG. 15 is a block diagram showing the schematic arrangement of the seventh embodiment of a processor according to the present invention. The processor of FIG. 15 includes a retreating register set determination unit 35 in addition to the arrangement of FIG. 12.

The retreating register set determination unit 35 determines register sets, which are retreated to an external register set storage 32, from the register sets in the register set group 21 based on the priorities supplied from a thread ID/priority supply unit 14. The register set transfer unit 34 transfers the contents of the register sets determined by the retreating register set determination unit 35 to the external register set storage 32, and transfers the contents of the register set read from the external register set storage 32 to the register set group 21.

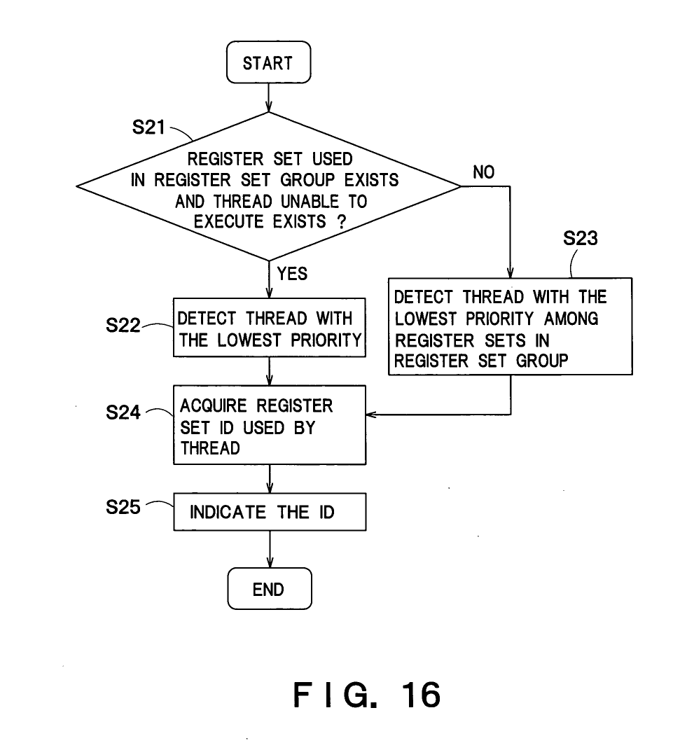

FIG. 16 is a flowchart showing the processing procedure of the retreating register set determination unit 35. First, it is determined whether or not register sets to be used exist in the register set group 21 as well as whether or not the threads corresponding to the register sets cannot be executed (step S21). When the determination at step S21 is YES, a thread having the lowest priority is selected from the threads (step S22).

In contrast, when the determination at S21 is NO, a thread having the lowest priority is selected from the threads corresponding to the respective register sets in the register set group 21 (step S23).

When the processing at step S22 or S23 is finished, the ID of the register set that is used by the selected thread is obtained (step S24) and indicated to the register set transfer unit 34 (step 25).

As described above, in the seventh embodiment, since the register sets, which must be retreated to the external register set storage 32, can be clearly designated, register sets, which are less frequently used, can be replaced, thereby the deterioration of a processing efficiency caused by retreating the register sets can be prevented.

(Eighth Embodiment)

Since the sixth and seventh embodiments described above execute the processing for determining whether or not the register set, which is used by the thread to be executed, exists in the register set group 21 by the hit determination unit 31, there is a possibility that a thread cannot be promptly switched. To solve the above problem, an eighth embodiment explained below processes the threads that are not affected by a result of determination of the hit determination unit 31 while the unit 31 executes a processing.

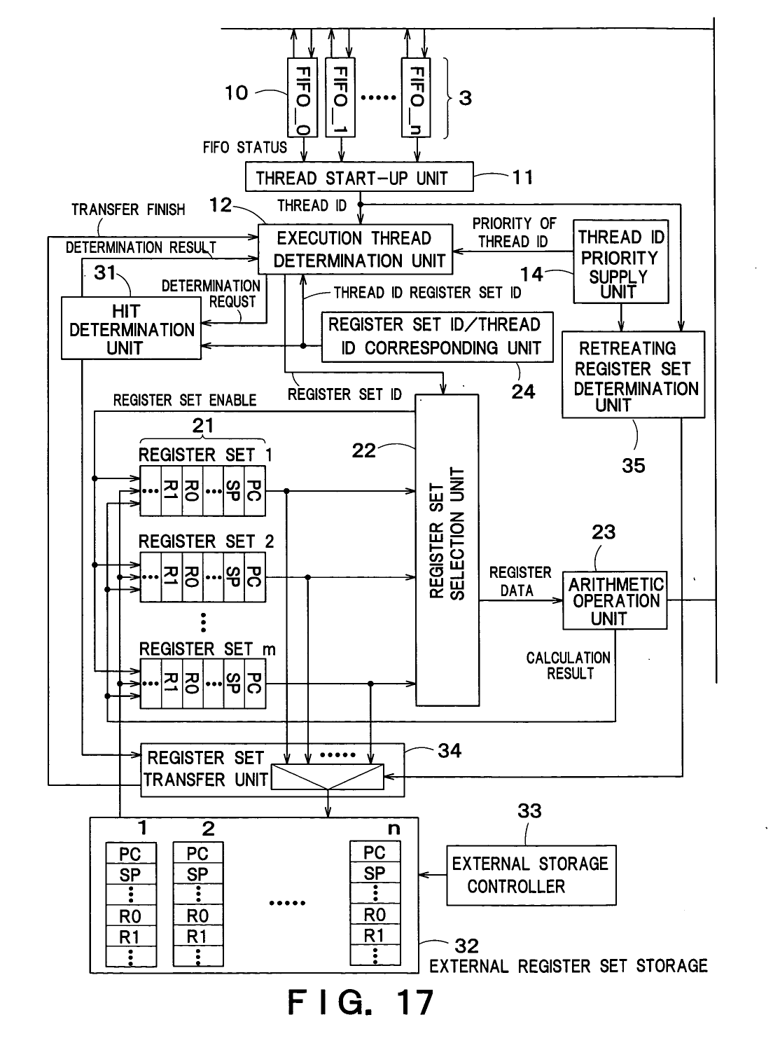

FIG. 17 is a block diagram showing the schematic arrangement of the eighth embodiment of a processor according to the present invention. An executing thread determination unit 12 of FIG. 17 executes a processing different from that of the executing thread determination unit 12 of FIG. 15. That is, the executing thread determination unit 12 of FIG. 17 requests a hit determination unit 31 to transmit a result of determination and receives the result of determination therefrom.

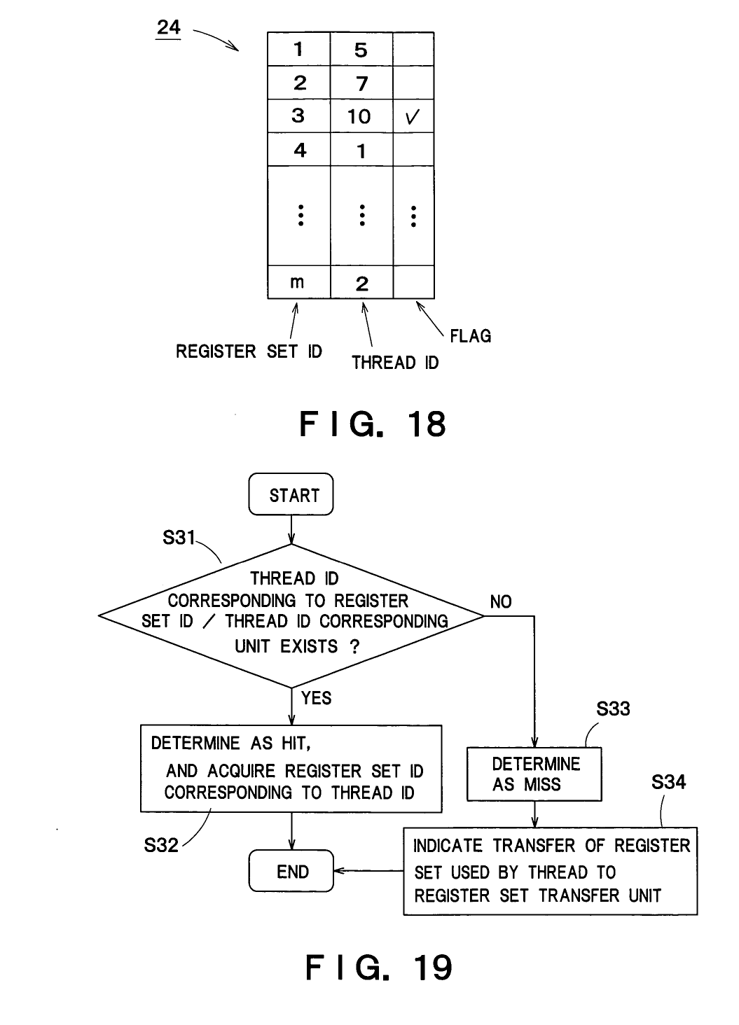

As shown in FIG. 18, a register set ID/thread ID corresponding unit 24 in FIG. 17 has flags in correspondence to respective thread IDs and register set IDs. The flags are set while a process is being executed to transfer the contents of a register set used by the thread from an external register set storage 32 because a thread, which is intended to be executed, is missed in the hit determination unit 31.

When the executing thread determination unit 12 switches a thread to be executed, it issues any one of a miss-time transfer hit determination request and a hit determination request. When the miss-time transfer hit determination request is issued, the executing thread determination unit 12 notifies a thread ID to the hit determination unit 31, and when the thread ID is missed, it indicates a register set selection unit 22 to transfer a register set which is used by the thread from an external register set transfer unit to the register set group 21.

The processing procedure of the hit determination unit 31 when it receives the miss-time transfer hit determination request is shown by a flowchart of FIG. 19. First, the hit determination unit 31 determines whether or not the thread ID of the thread to be executed is registered in the register set ID/thread ID corresponding unit 24 (step S31). When the thread ID is registered, the register set ID corresponding to the thread ID is obtained (step S32), whereas when the thread ID is not registered, the hit determination unit 31 determines that the thread ID is missed (step S33), and the executing thread determination unit 12 indicates the register set transfer unit 34 to transfer the register set used by the thread (step S34).

In contrast, when the hit determination request is issued, the thread ID is notified to the hit determination unit 31, and hit determination is executed excluding the register set whose flag is valid. Even if the thread ID is missed, no register set is transferred.

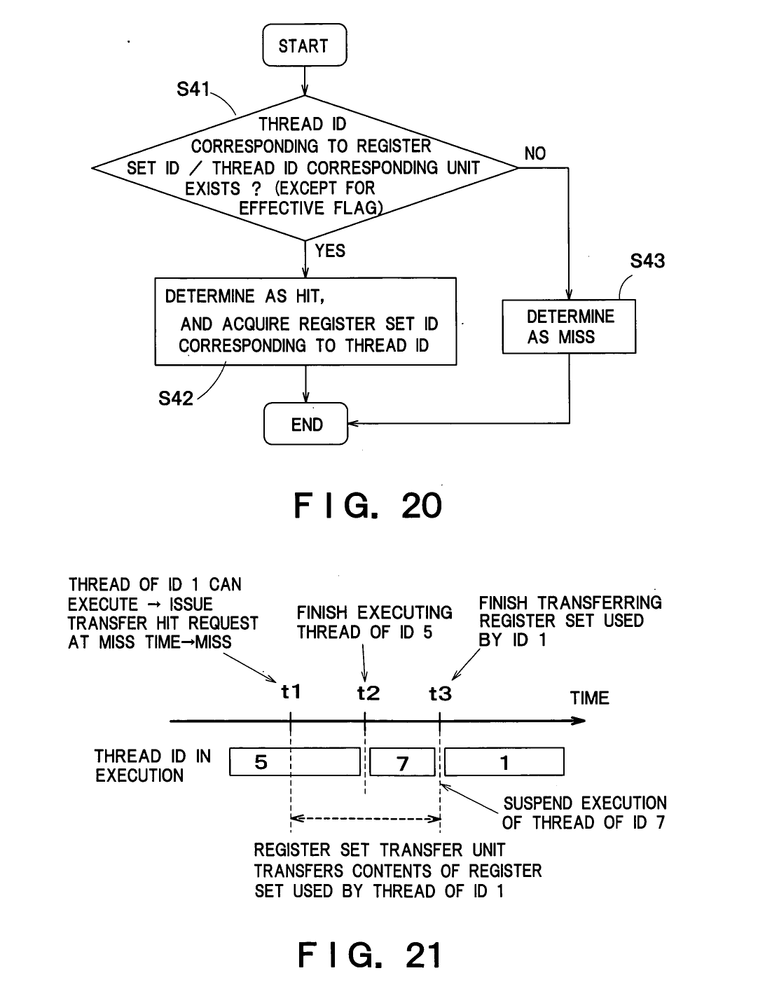

When the hit determination unit 31 receives the hit determination request, it executes the processing procedure shown by a flowchart of FIG. 20. First, the hit determination unit 31 determines whether or not the thread ID of the thread to be executed is registered in the register set ID/thread ID corresponding unit 24 excluding the thread ID whose flag is set (step S41). When the thread ID is registered, the register set ID corresponding to the thread ID is obtained (step S42), whereas when the thread ID is not registered, the hit determination unit 31 determines that it is missed (step S43).

When no set flag exists in the register set ID/thread ID corresponding unit 24 and the executing thread determination unit 12 switches a thread to be executed, the executing thread determination unit 12 issues the miss-time transfer hit determination request, upon switching the thread ID of the thread. When the thread ID is hit, the executing thread determination unit 12 obtains the register set ID corresponding to the new hit thread ID from the register set ID/thread ID corresponding unit 24, notifies the register set ID to the register set selection unit 22, and starts the execution of the new thread. In contrast, when the thread ID of the switched thread is missed, the hit determination unit 31 indicates the register set transfer unit 34 to transfer a register set, and the register set ID/thread ID corresponding unit 24 sets a flag corresponding to the register set to be transferred.

When the register set has been transferred, the register set transfer unit 34 notifies the register set ID/thread ID corresponding unit 24 that the register set has been transferred. The register set ID/thread ID corresponding unit 24 invalidates the flag of the register set invalid according to the notification.

The executing thread determination unit 12 obtains the register set ID corresponding to the thread to be executed from the register set ID/thread ID corresponding unit 24, notifies the obtained register set ID to the register set selection unit 22, and starts the execution of the thread.

When a set flag exists in the register set ID/thread ID corresponding unit 24 and the executing thread determination unit 12 switches a thread to be executed, the executing thread determination unit 12 issues the hit determination request as to the thread ID of the thread having been switched. When the thread ID is hit, the executing thread determination unit 12 obtains the register set ID corresponding to the new hit thread ID from the register set ID/thread ID corresponding unit 24, notifies the register set ID to the register set selection unit 22, and starts the execution of the new thread. In contrast, when the thread ID is missed, the thread is not switched.

FIG. 21 is a view explaining an execution mode of a thread when the set flag exists in the register set ID/thread ID corresponding unit 24. In this example, when it is possible to execute a thread with a thread ID 1 whose priority is higher than that of a thread with a thread ID 5 being executed, the executing thread determination unit 12 issues the miss-time transfer hit determination request to the hit determination unit 31.

In this example, the hit determination unit 31 receiving this request determines the occurrence of the miss, thereby the register set transfer unit 34 starts to transfer a register set used by the thread ID 1 from the register set group 21. This transfer takes time until a time t3.

When the execution of the thread ID 5 is finished at a time t2 between a time t1 and the time t3, the executing thread determination unit 12 requests to determine whether or not a thread having the highest priority in the executable threads (thread ID 7 in the example FIG. 21) is hit. When the thread ID 7 is hit, the thread ID7 is executed.

Thereafter, at the time t3, the completion of transfer is notified from the register set transfer unit 34, thereby the executing thread determination unit 12 starts the execution of the thread ID 1.

As described above, when a register set used by a thread is being transferred, other thread, which does not affect the execution of the thread, is executed in the eighth embodiment. Accordingly, the thread can be processed without the need of waiting the completion of transfer of the register set, thereby a thread processing efficiency can be improved.

(Ninth Embodiment)

In a ninth embodiment, each of the registers constituting a register set is provided with a flag for showing whether or not the contents of the register is updated.

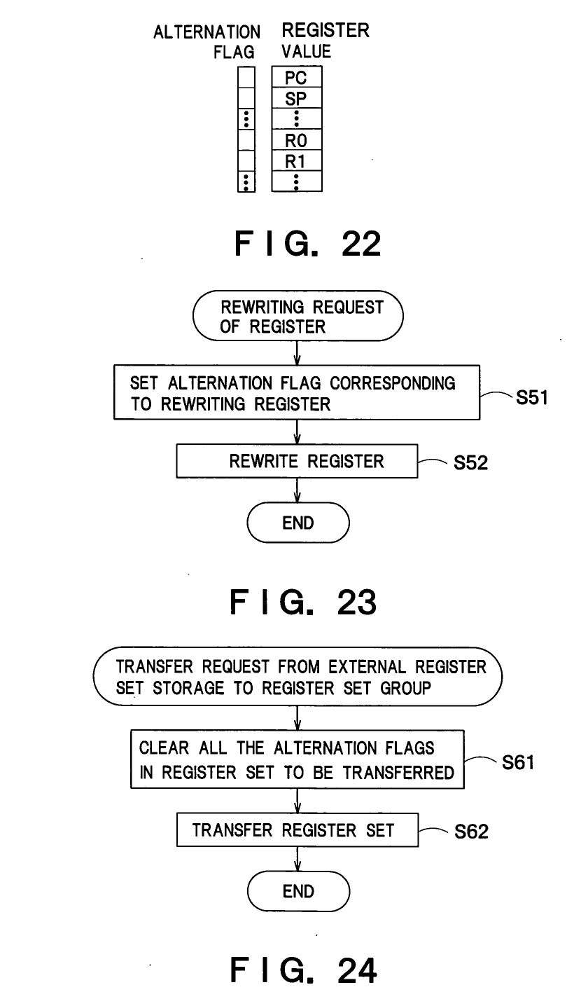

Although the ninth embodiment has the same block arrangement as that of FIG. 12, the register sets of a register set group 21 have a data structure different from that of FIG. 12. FIG. 22 is a view showing the data structure of the register sets of the ninth embodiment. As shown in FIG. 22, there are provided alteration flags in correspondence to the respective registers constituting the register set. The alteration flags are set when the contents of corresponding registers are rewritten. A processing procedure in this case is shown by a flowchart shown in FIG. 23.

In FIG. 23, first, the alteration flag corresponding to a register to be rewritten is set (step S51), and thereafter the register is rewritten (step S52).

The alteration flags of FIG. 22 are cleared when the register sets stored in an external register set storage 32 are read. A processing procedure, which is executed when the contents of a register set are transferred from the external register set storage 32 to the register set group 21, is shown by a flowchart shown in FIG. 24.

In FIG. 24, first, all the alteration flags in the register set to be transferred are cleared (step S61), and thereafter the contents of the register set is transferred (step S62).

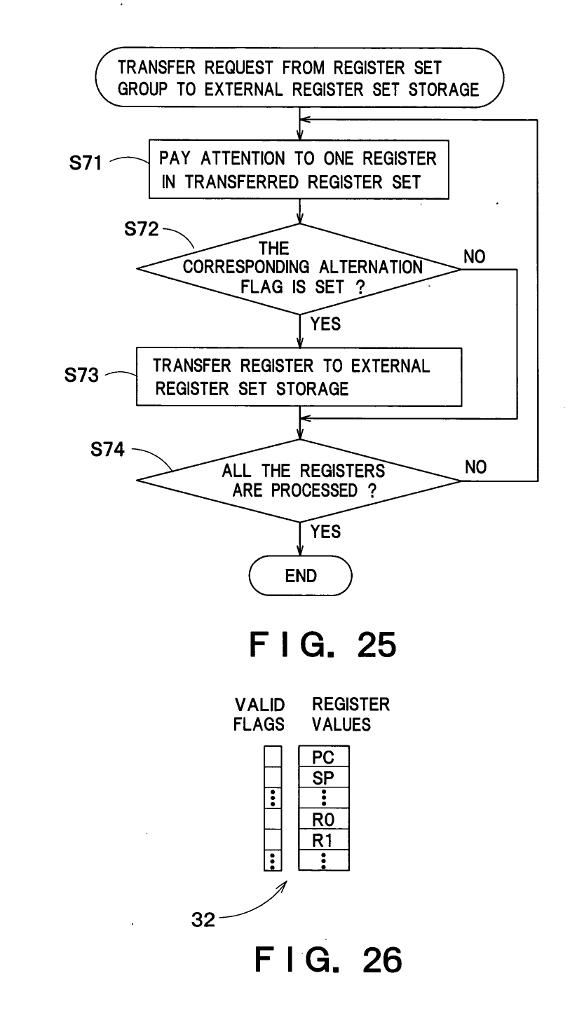

FIG. 25 is a processing procedure executed by a register set transfer unit 34 when the register set group 21 requests the external register set storage 32 to transfer the contents of the register set. First, attention is paid to a register in the register set whose contents are transferred (step S71), and it is determined whether or not the alteration flag of the register set to which the attention is paid is set (step S72).

When the alteration flag is set, the contents of the resister set to be transferred is transferred to the external register set storage 32 (step S73). When the alteration flag is not set or when the processing at step S73 is finished, it is determined whether or not all the resisters have been processed (step S74), and when some of the registers have not been processed, the process returns to step S71, whereas when all the registers have been processed, the process is finished.

As described above, in the ninth embodiment, since only the contents of the resisters which are altered are transferred to the external register set storage 32 in the registers included in the register set group 21, an amount of data to be transferred can be reduced, thereby a transfer time can be decreased.

(Tenth Embodiment)

In the tenth embodiment, an external register set storage 32 include flags therein which show whether or not the respective registers of respective register sets are rewritten.

FIG. 26 is a view showing the data structure of the external register set storage 32. As shown in FIG. 26, the valid flags are provided in correspondence to the respective registers of the respective register sets. The valid flags are set when corresponding registers are rewritten.

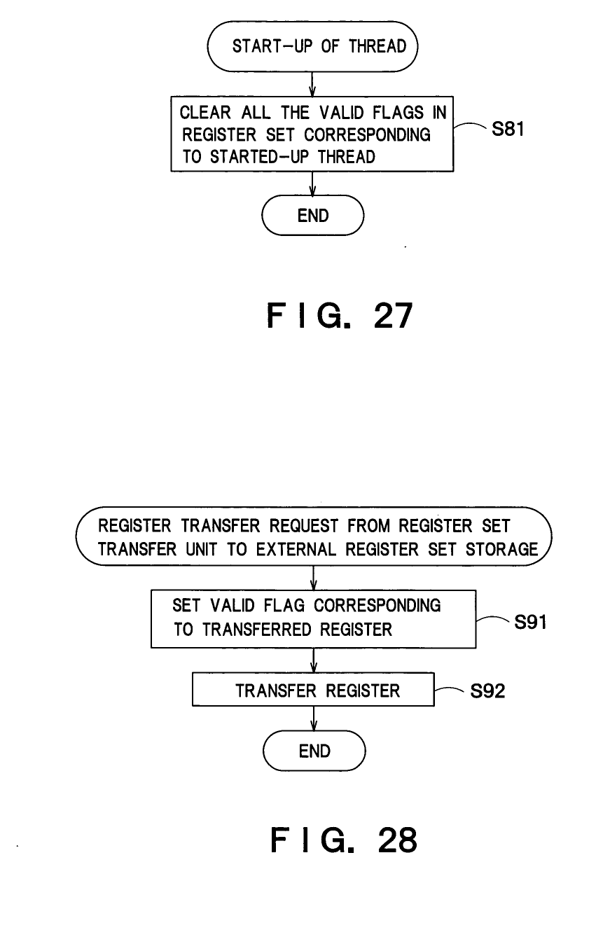

FIG. 27 is a flowchart showing a processing for initializing the valid flags, this processing is executed by an external storage controller 33 when a thread is started. The external storage controller 33 clears all the valid flags in the register set corresponding to the thread to be started (step S81).

FIG. 28 is a flowchart of a processing for setting the valid flags, and the processing is executed by the external storage controller 33 when a register set transfer unit 34 requests the external register set storage 32 to transfer the contents of a register set. The external storage controller 33 sets the valid flag corresponding to a register whose contents are transferred by the external register set storage 32 (step S91). Thereafter, the contents of the register are transferred from the register set group 21 to the external register set storage 32 (step S92).

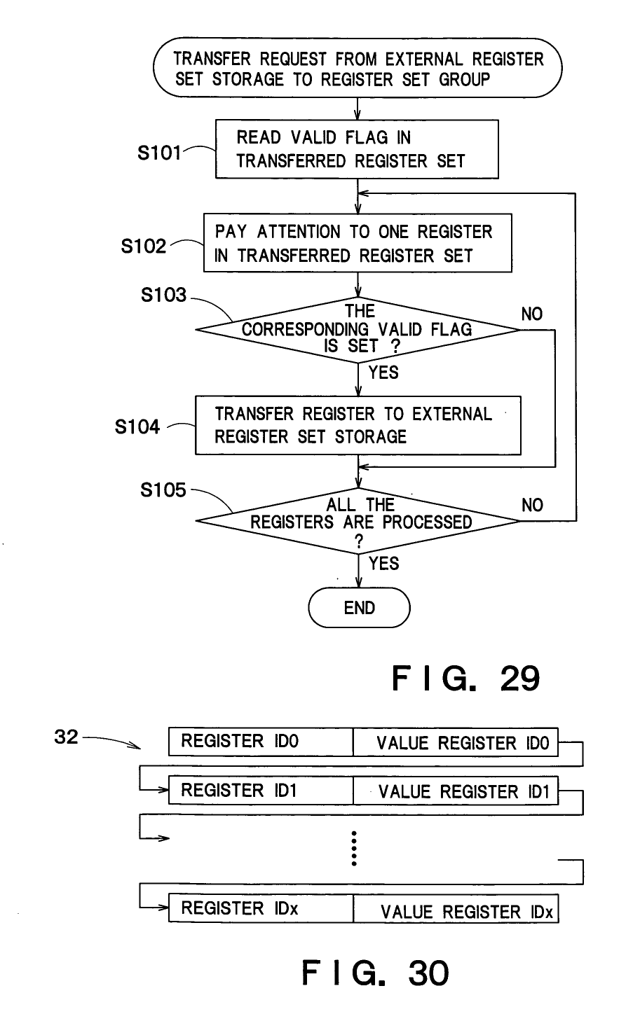

FIG. 29 is a flowchart showing a processing procedure, which is executed by the external storage controller 33 when the external register set storage 32 requests a transfer to the register set group 21. First, the valid flag in the register set to be transferred is read (step S101). Next, attention is paid to a register in the register set to be transferred (step S102).

It is determined whether or not the valid flag corresponding to this register is set (step 103), and when it is set, the register is transferred to the external register set storage 32 (step S104). Next, it is determined whether or not all the registers have been processed (step S105), and when some of the registers have not been processed, the step S101 and the subsequent steps are repeated.

As described above, the tenth embodiment provides the valid flags, which show whether or not the registers have been rewritten, in the external register set storage 32. Accordingly, the contents of the registers are transferred from the external register set storage 32 to the register set group 21 only when the contents thereof are rewritten, thereby the number of times of the transfer of the contents can be reduced, and a transfer time can be also decreased.

(Eleventh Embodiment)

An eleventh embodiment arranges the register sets of the respective threads of an external register set storage 32 as a list structure.

FIG. 30 is a view showing the data structure of the external register set storage 32 of the eleventh embodiment. The external register set storage 32 has the list structure and stores a register value storing region, which stores the values of the registers whose contents are altered, and the identification numbers (register IDs) of the registers stored in the register value storing region (register IDs) as a set. That is, the external register set storage 32 does not store the values of the registers whose contents are not altered.

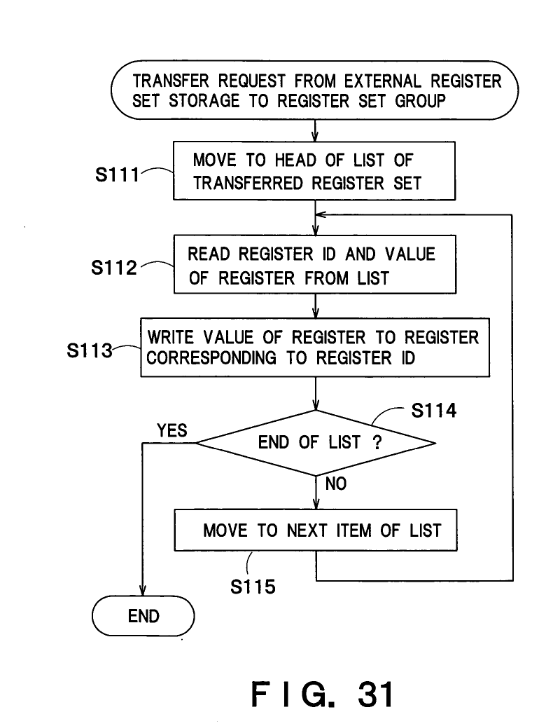

FIG. 31 is a flowchart showing the processing procedure of an external storage controller 33 when the external register set storage 32 requests a register set group 21 to transfer the contents of a register set. First, a pointer is moved to the leading head of the list of the register set to be transferred (step S111). Next, a register ID and the value of a register are read from the list of the external register set storage 32 (step S112). Next, the value of the register is written to the register, which corresponds to the register ID, of the register set group 21 (Step S113). Next, it is determined whether or not the end of the list is reached (step S114). When it is determined that the end of the list is reached, the processing is finished, whereas when the end of the list is not reached, the process goes to a next item in the list and repeats step S111 and the subsequent steps.

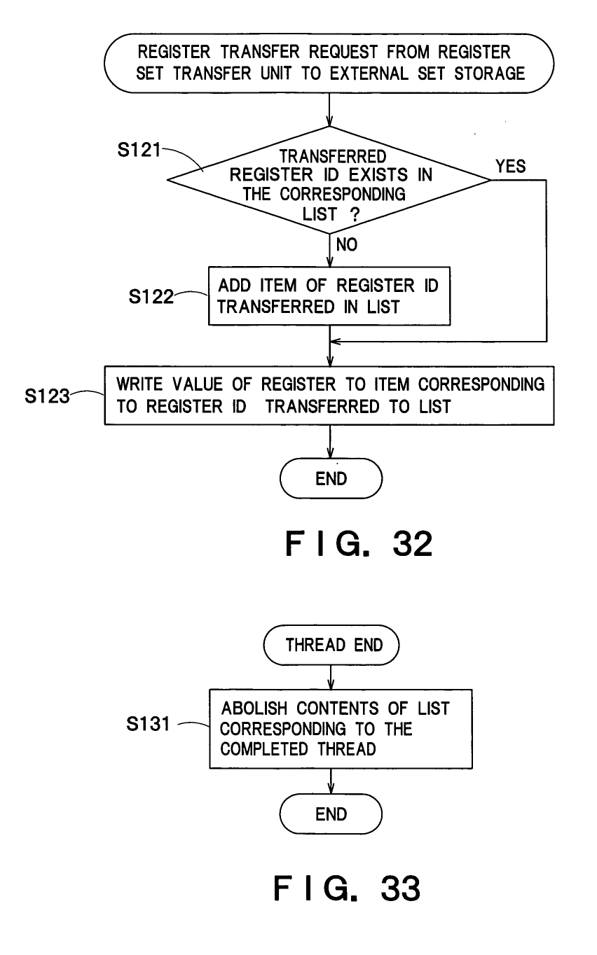

FIG. 32 is a flowchart showing the processing procedure executed by an external storage controller 33 when a register set transfer unit 34 requests the external register set storage 32 to transfer the contents of a register. First, it is determined whether or not a register ID to be transferred exists in a corresponding list of the external register set storage 32 (step S121). When the register ID to be transferred does not exist in the list, the item of the register ID is added to the list (step S122).

When it is determined that the register ID exists in the list at step S121 or when the processing at step S122 has been finished, the value of the register is written to a register value storing region which corresponds to the register ID to be transferred in the list (step S123).

FIG. 33 is a flowchart showing the processing procedure executed by the external storage controller 33 when the processing of the thread has been finished. The contents of the list, which corresponds to the finished thread in the external register set storage 32, is abandoned (step S131).

As described above, in the eleventh embodiment, the external register set storage 32 is arranged as the list structure, and only the values of the registers whose contents have been altered are stored. Accordingly, the memory capacity of the external register set storage 32 can be reduced, and an amount of data transferred between the external register set storage 32 and the register set group 21 can be also reduced.

(Twelfth Embodiment)

The twelfth embodiment determines the priorities of threads according to the amounts of data stored in input side and output side FIFO memories.

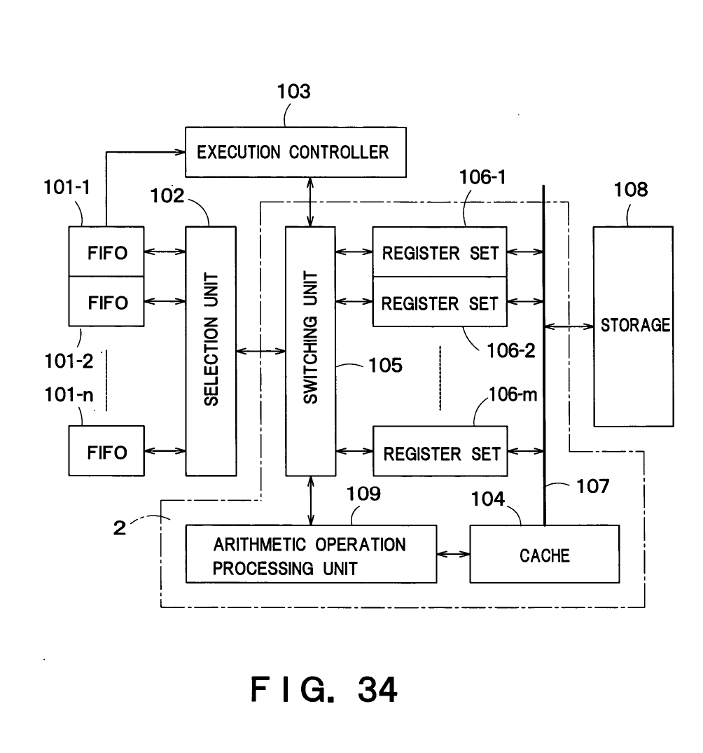

FIG. 34 is an example of the block diagram of a processor in the twelfth embodiment. The processor of FIG. 34 includes a plurality of the FIFO memories 101, a selection unit 102, an execution controller 103, a cache 104, a switching unit 105, a plurality of register sets 106, a memory bus 107, and a memory unit 108, and an arithmetic operation processing unit 109. The cache 104, the switching unit 105, the register sets 106, and the arithmetic operation processing unit 109 correspond to a processor core 2.

The FIFO memories 101 are memory units capable of reading data on the first in, first out basis. Although the plurality sets of FIFO memories 101 are provided, they can be discriminated from each other by suffixes such as FIFO 101₋₁, . . . FIFO 101₋ₙ attached thereto.

Although it is not always necessary for the respective FIFO memories 101 to have the same memory capacity, it is assumed that they have the same memory capacity in order to simplify explanation.

The threads can be processed by controlling the respective units by the execution control unit 103 and by executing a predetermined program code given previously by the arithmetic operation processing unit 109 under the control of the execution controller 103.

The selection unit 102 selects a FIFO memory designated by the execution controller 103 from the FIFO memories 101. Data is written to and read from the selected FIFO memory by the arithmetic operation processing unit 109.

The execution controller 103 has a function for controlling the overall processings executed by the processor of this embodiment. A table, which holds the priorities for indicating a thread to be executed preferentially, is included here. The execution controller 103 sets the table based on the information of the FIFO memories 101 and the like and has a function for indicating data to be processed and a thread to be executed according to the contents of the table to the respective units.

The cache 104 is provided to prevent a sequential access to memory units having a low read/write speed when the arithmetic operation processing unit 109 executes the program cord corresponding to a thread. In general, the access speed of a large capacity memory unit such as a main memory and a magnetic disc device is lower than the processing speed of the arithmetic operation processing unit 109. Although the memory capacity of the cache 104 is not as large as large that of the large capacity memory unit, the cache 104 employs a memory unit having a high access speed. When data is written and read, a waiting time of the arithmetic operation processing unit 109 is eliminated by storing the data and program codes, which are frequently accessed, in the cache 104 once, thereby the amount of data processed by the arithmetic operation processing unit 109 can be increased as much as possible.

The switching unit 105 selects at least one register set, which is necessary to processing, from the plurality of register sets 106 so that it can be accessed. The arithmetic operation processing unit 109 accesses a register set, in which data necessary to the processing is stored, through the switching unit 105.

Each of the register sets 106 integrates various kinds of registers (temporary memory units) that are needed by the execution controller 103 when it executes a program code. Each register set 106 includes, for example, a calculation register, an addressing register, a task pointer, and the like. This embodiment is provided with the plurality of register sets 1 to m (m: arbitrary number). It is not necessary for the respective register sets 106 to have the same arrangement, they preferably have the same arrangement so that the respective threads can be processed even if any of the register sets is used.

The memory bus 107 is provided to transmit data among the cache 104, the plurality of register sets 106, and the memory unit 108. The cache 104, the plurality of register sets 106, and the memory unit 108 transmit the data through the memory bus 107. The data is transmitted under the control of the execution controller 103.

The memory unit 108 stores the program code, which is executed by the processor of the embodiment to execute the processing, and the data to be processed. In some cases, the memory unit 108 is used to temporarily save the data stored in the cache 104 and the register sets 106.

The arithmetic operation processing unit 109 has a function for executing the program code stored in the memory unit 108 or the cache 104. When the program code is executed, a FIFO memory 101 and a register set 106 to be used and a thread to be processed are determined according to an indication from the execution controller 103.

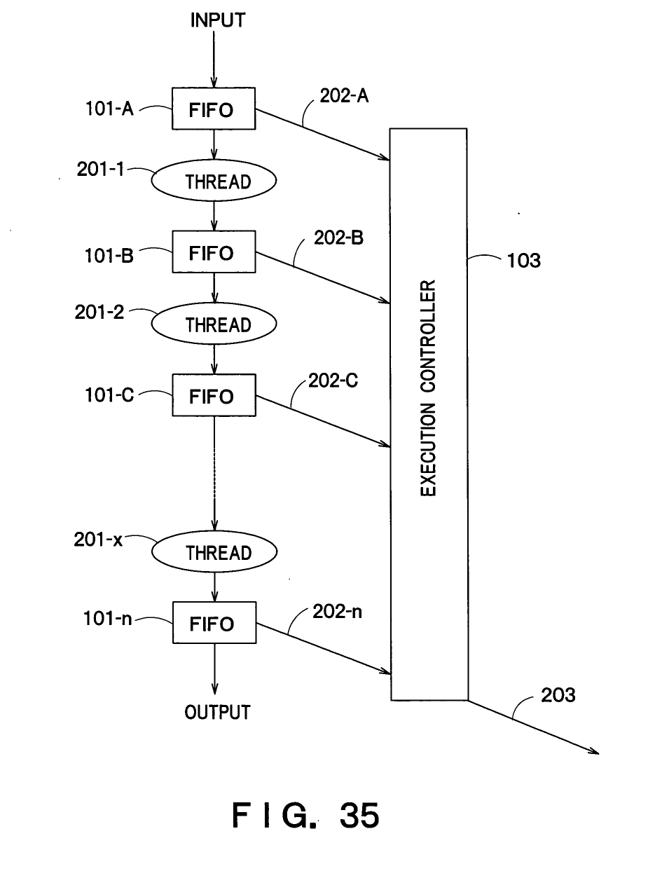

FIG. 35 is a view explaining the outline of the thread processing executed by the processor of the embodiment. Since the processor of the embodiment is of a data-flow type, processing data is supplied in the form of an input, and an output can be basically obtained through a flow. As to the input processing data, threads 201₋₁ to 201_{-X} are sequentially processed according to the program code previously stored in the memory unit 108 by the arithmetic operation processing unit 109. When a processing is executed in a next stage, a result of output is used as input data of the next stage.

When the processing data as the input data is supplied, a FIFO memory 101_{-A}, which is one of the plurality of FIFO memories 101 indicated by the execution controller 103, stores the processing data. The FIFO memory 101_{-A} notifies the FIFO accumulation amount in it to the execution controller 103 as a state report 202_{-A} spontaneously or in response to a request from the execution controller 103 and the like.

When the arithmetic operation processing unit 109 starts the execution of a thread 201₋₁ in response to the indication from the execution controller 103, the data in the FIFO memory 101_{-A} is processed as the input data. At this time, the data in the FIFO memory 101_{-A} is sequentially read out on the First-In, first out basis. A result of processing executed by the thread is stored in a FIFO memory 101_{-B} in response to an indication from the execution controller 103. The FIFO memory 101_{-B} also notifies a state report 202_{-B} including a FIFO accumulation amount to the execution controller 103 likewise the FIFO memory 101_{-A}.

When the processing has been finished as to the thread 201₋₂ to the thread 201_{-X} (x is an arbitrary number), a result of the processing is supplied as an output.

A thread to be executed by the arithmetic operation processing unit 109 is indicated by an execution indication 203 from the execution controller 103. The execution controller 103 sets priorities in an execution priority table provided therewith based on the state reports 202_{-A} to 202₋ₙ notified by the FIFO memories 101_{-A} to 101₋ₙ and determines the execution indication 203 from the priorities. The execution indication 203 may be determined according to the priorities determined using only a part of the plurality of state reports 202, or a thread 201 having the highest priority may be determined from the priorities determined in consideration of all the state reports 202. It is preferable to determine the sequence for executing the respective threads 201 from all the state reports 202 SO as to improve a processing efficiency in its entirety.

A method of determining the execution sequence of the threads by the execution controller 103 will be explained below.

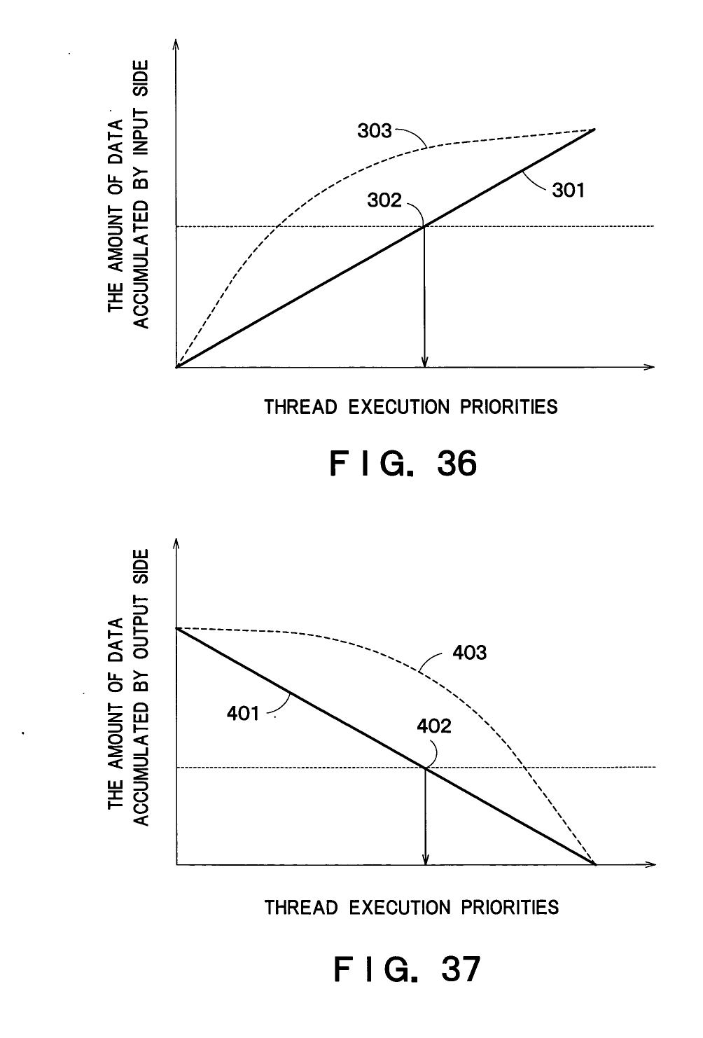

FIG. 36 is a graph showing an example of a method by which the execution controller 103 of the embodiment determines the execution priority of a thread with respect to the amount of data accumulated by the input side FIFO memory for the thread. Since the amount of data accumulated by the FIFO memory corresponding to the vertical axis of FIG. 36 shows the amount of data accumulated by the input side FIFO memory, the FIFO memory corresponds to, for example, the FIFO memory 101_{-A} with respect to the thread 201₋₁ and the FIFO memory 101_{-B} with respect to the thread 201₋₂ shown in FIG. 35.

A large amount of processing-waiting data accumulated in the input side FIFO memory of a thread means that the processing of the thread is delayed. Accordingly, the processing-waiting data must be processed promptly by raising the priority of the thread. For this purpose, the priority of the thread is set such that it can be more easily executed as the amount of data accumulated by the input side FIFO memory increases (the priority of the thread is increased) as shown in FIG. 36. As shown by a point of intersection 302, a larger amount of data accumulated by the input side FIFO memory causes the execution controller 103 to set a higher priority through the table that shows the priorities of the respective threads.

Although the example of FIG. 36 shows the relationship between the amount of data accumulated by the input side FIFO memory and the execution priority of the thread by a proportional straight line 301, it is not necessarily be shown by the straight line. For example, the relationship may be shown by a proportional curved line 303 which is set such that the priority is more raised as the amount of data accumulated by the input side FIFO memory approaches an upper limit. In this case, the overflow of the input side FIFO memory can be effectively prevented. Further, the priority may be raised stepwise without depending on the curved or straight line so that it can be easily realized when the processor is designed. As an example, it is also possible to set a threshold value to the amount of data accumulated by the input side FIFO memory and not to operate a thread until the threshold value is exceeded or to continuously operate the thread until the threshold value is broken.

FIG. 37 is a view showing an example of a method of determining the priority of a thread with respect to the amount of data accumulated by an output side FIFO memory in the processor of the embodiment. Since the amount of data accumulated by the FIFO memory corresponding to the vertical axis of FIG. 37 shows the amount of data accumulated by the output side FIFO memory, the FIFO memory corresponds to, for example, the FIFO memory 101_{-B} with respect to the thread 201₋₁ and the FIFO memory 101_{-C} with respect to the thread 201₋₂ shown in FIG. 35.

A large amount of processing-waiting data accumulated in the output side FIFO memory of a thread means that the processing of a succeeding thread is delayed. When the thread is executed as it is, there is a possibility that the output side FIFO memory is overflowed. To solve such a problem, it is necessary to restrict the processing by lowering the priority of the thread so that the output side FIFO memory is not overflowed. For this purpose, the priority of the thread is set to make it more difficult to execute the thread (the priority thereof is decreased) as the amount of accumulation in the output side FIFO memory increases as shown in FIG. 37. As shown by a point of intersection 402, a larger amount of data accumulated by the output side FIFO memory causes the execution controller 103 to set a lower priority through the table that shows the priorities of the respective threads.

Although the example of FIG. 37 shows the relationship between the amount of data accumulated by the output side FIFO memory and the execution priority of the thread by a proportional straight line 401, it is not necessarily be shown by the straight line. For example, the relationship may be shown by a proportional curved line 403 which is set such that the priority is more decreased as the amount of data accumulated by the output side FIFO memory approaches an upper limit. In this case, the overflow of the output side FIFO memory can be effectively prevented. Further, the priority may be lowered stepwise without depending on the curved or straight line so that it can be easily realized when the processor is designed. As an example, it is also possible to set a threshold value to the amount of data accumulated by the output side FIFO memory and not to operate a thread until the threshold value is broken or to continuously operate the thread until the threshold value is exceeded.

As described above, the execution controller 103 determines the priorities of the threads according to the priorities that are obtained by synthesizing both the priorities obtained from the input side and output side FIFO memories or according to the priorities based on the input side FIFO memories.

At this time, it is also contemplated that the priority obtained from the amount of data accumulated by the input side FIFO memories contradicts the priority obtained from the amount of data accumulated by the output side FIFO memory. For example, there is contemplated a case that the amounts of accumulation of both the input side and output side FIFO memories are near to the upper limits thereof. In this case, the priority determined based on the amount of data accumulated by the input side FIFO memory is preferentially employed under the condition that the vacant region of the amount of data accumulated by the output side FIFO memories has a region in which a result of output, which is obtained after the processing data stored in the input side FIFO memory has been processed, can be stored. Except for the above case, the priority determined based on the amount of data accumulated by the output side FIFO memory is preferentially employed or the execution of the thread having the priority is temporarily prohibited to prevent the overflow of the output side FIFO memory.

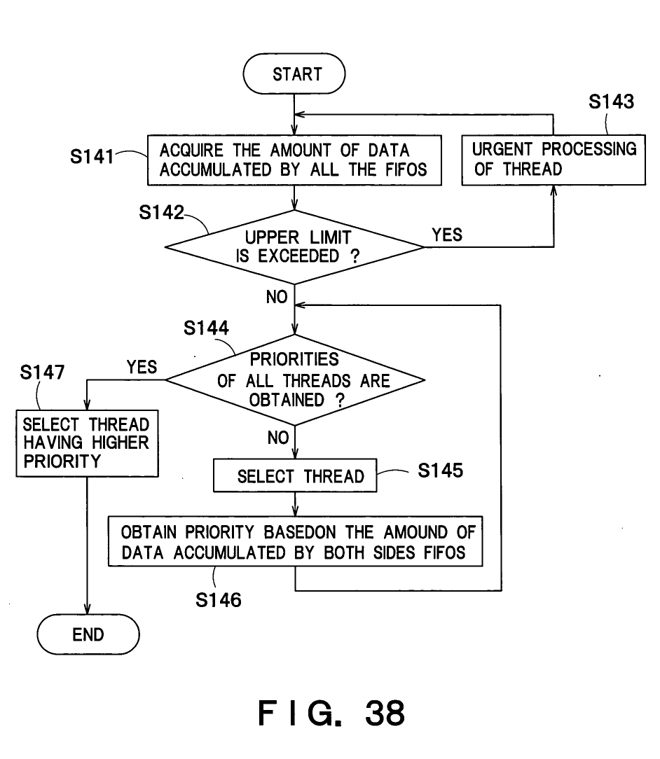

FIG. 38 is a flowchart showing an example for determining a thread that is executed next by the processor of the embodiment.

First, the amounts of accumulation of all the FIFO memories are obtained (step S141). A method of obtaining the amounts of accumulation may be inquired to the respective FIFO memories or may be spontaneously reported therefrom.

The obtaining method is not particularly limited.

Next, the respective FIFO memories are checked to find that any one of them has an amount of accumulation that may exceed the upper limit of the amount of accumulation (step S142). When there is a FIFO memory whose amount of accumulation may exceed the upper limit, an urgent processing is executed to the thread relating to the FIFO memory (step S143).

The following processings, for example, are executed as the urgent processing. One of them is to process a thread having the FIFO memory on the input side thereof most preferentially by interruption. The interruption is a means for forcibly changing an ordinary processing sequence. The amount of data accumulated by the FIFO memory can be reduced by processing the thread in preference to other threads. The other processing is to temporarily prohibit the execution of the thread having the FIFO memory on the output side thereof. Additional data supplied to the FIFO memory is stopped by preventing the execution of the thread, thereby a margin is given to the amount of accumulation.

The contents of the urgent processings must be flexibly determined in consideration of a processing state and the characteristics of processing data, and are not limited to the examples described above.

When there is no FIFO memory that seems to overflow, it is determined next whether or not the priorities of all the threads have been determined (step S144).

When the priorities of all the threads have not been determined, one of the threads which are being processed or in wait is selected (step S145). Then, the priority of the selected thread is determined by the above method from the amounts of accumulation of the input side and output side FIFO memories used by the selected thread (step S146). After the priority has been determined, it is determined again whether or not the priorities of all the threads have been determined (step S144).

When it is determined that the priorities of all the threads have been determined, a thread having the highest priority is selected from the threads whose priorities have been determined (step S147).

With the above operation, a thread to be executed next can be selected from the threads which are being processed or in wait.

With the above arrangement, the processing capability of the data-flow type processor can be effectively allocated to necessary processings as well as a thread to be executed can be selected according to the amounts of accumulation of the input side and output side FIFO memories.

Further, it is also possible to arrange a computer on which the processor of this embodiment is implemented and which executes data-flow type processings.

As described above, in the twelfth embodiment, as a larger amount of data is accumulated in an input side FIFO memory, a higher priority is set to a thread using the data of the input side FIFO memory. Accordingly, the processing-waiting data of the input side FIFO memory can be promptly processed. Further, as an output side FIFO memory accumulates a larger amount of data, the priority of the thread before an output side FIFO memory is lowered, thereby the output side FIFO memory can be prevented from being overflowed.

(Thirteenth Embodiment)

In a third embodiment, the priority of a thread is switched the period during which the amounts of accumulation of input side and output side FIFO memories increase and the period during which they decrease.

The block arrangement of a processor and the processing of threads in the thirteenth embodiment are the same as those of FIGS. 34 and 35.

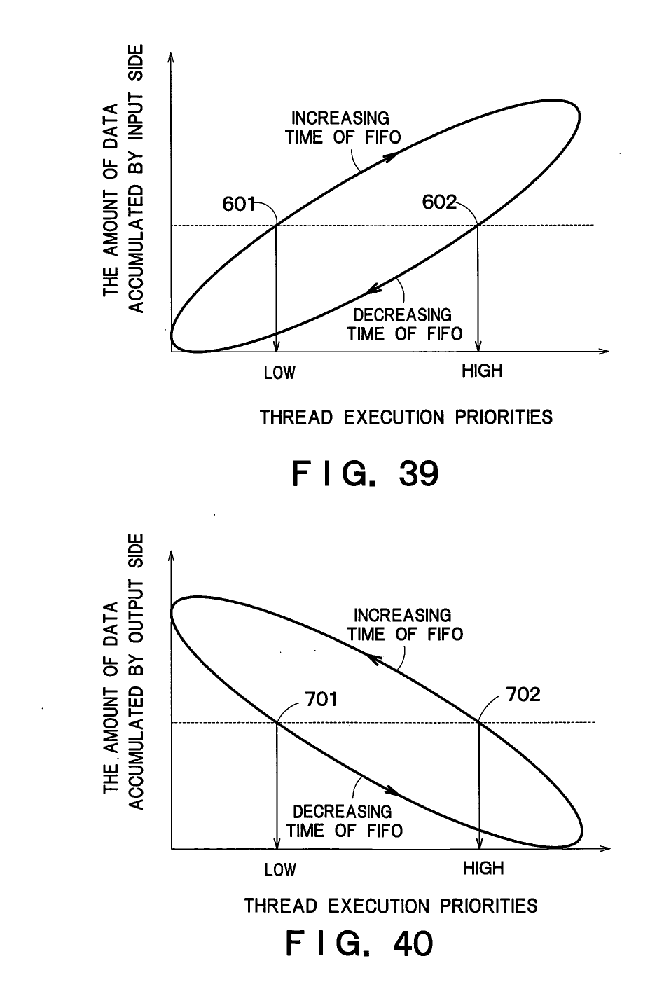

FIG. 39 is a graph showing an example of a method of determining the priority of a thread with respect to the amount of data accumulated by an input side FIFO memory in the processor of the embodiment. Since the amount of data accumulated by the FIFO memory corresponding to the vertical axis of FIG. 39 shows the amount of data accumulated by the input side FIFO memory, the FIFO memory corresponds to, for example, the FIFO memory 101_{-A} with respect to the thread 201₋₁ and the FIFO memory 101_{-B} with respect to the thread 201₋₂ shown in FIG. 35.

A large amount of process-waiting data accumulated in the input FIFO memory of a thread means that the processing of the thread is delayed. Accordingly, the processing-waiting data must be processed promptly by increasing the priority of the thread. For this purpose, the priority of the thread is set such that it can be more easily executed as the amount of data accumulated by the input FIFO memory increases (the priority of the thread is increased) as shown in FIG. 39.

The thirteenth embodiment is different from the twelfth embodiment in that a different thread execution priority is set between the period during which the amounts of accumulation of the FIFO memories increase and the period during which they decrease. Even if the FIFO memory have the same amount of accumulation, the priority of a thread at a point of intersection 601 at which the amount of data accumulated by the FIFO memory increases, for example, is lower than that of the thread at a point of intersection 602 at which the amount of data accumulated by the FIFO memory decreases.

When the relationship between the amount of data accumulated by the input side FIFO memory and the processing of a thread is considered, there is a tendency that when the thread is executed, the amount of data accumulated by the input side FIFO memory is decreased, whereas when the thread is not executed, it is increased. At this time, when the decrease of the amount of data accumulated by the FIFO memory including the point of intersection 602 is considered, even if the amount of data accumulated by the input side FIFO memory is decreased, the priority of the thread is moderately lowered. On the contrary, when the increase of the amount of data accumulated by the FIFO memory including the point of intersection 601 is considered, even if the amount of data accumulated by the input side FIFO memory is increased, the priority of the thread is moderately increased. That is, even if the amount of data accumulated by the input side FIFO memory is changed, there is a great possibility that the thread whose processing is started once is continuously executed because the priority thereof is maintained at a high level. On the contrary, this means that when the priority of a thread is lowered and thus the execution of the thread becomes difficult, it is difficult to execute the thread unless the amount of data accumulated by the input side FIFO memory is more increased.

The cache 104 shown in FIG. 34 is provided to access the processing data, which must be subjected to a thread processing, at a high speed although its memory capacity is small, as described above. Since the memory capacity of the cache 104 is small, there is a great possibility that when other thread is executed, the processing data of the thread that has been read once is overwritten and deleted. The deleted processing data must be read again onto the cache 104 from a memory unit having a low access speed. When a thread to be executed is often changed by the variation of the amount of data accumulated by the input side FIFO memory, the amount and the number of times of read of the data that must be read from the other memory unit to the cache 104 are inevitably increased.

When the number of the threads, which are being executed or in wait, is large than the number of the register sets 106 shown in FIG. 34, the processing data of the threads must be also temporarily saved to the other memory unit. This is because, to execute a thread that is not allocated to a register set 106 at a time, a register set 106 occupied by other thread must be released for the above thread. Since the contents of the register set 106 must be moved between memory units, an overhead is caused by frequently switching the threads likewise the cache 104.

In the processor of this embodiment, the overhead that is caused when data is read to the cache 104 is reduced by realizing a state that a certain thread is liable to be executed frequently. Accordingly, the processing capability of the processor can be applied to intrinsic data processings.

Although the example of FIG. 39 shows the relationship between the amount of data accumulated by the FIFO memory and the priority of the thread by an ellipse, it is not necessarily ellipse. For example, the priority may be set to be raised stepwise so that it can be easily realized when the processor is designed.

FIG. 40 shows an example of a method of determining the priority of a thread with respect to the amount of data accumulated by an output side FIFO memory in the processor of the embodiment. Since the amount of data accumulated by the FIFO memory corresponding to the vertical axis of FIG. 40 shows the amount of data accumulated by the output side FIFO memory, the FIFO memory corresponds to, for example, the FIFO memory 101_{-B} with respect to the thread 201₋₁ and the FIFO memory 101_{-C} with respect to the thread 201₋₂ shown in FIG. 35.

A large amount of processing-waiting data accumulated in the output side FIFO memory of a thread means that the processing of a succeeding thread is delayed. When the thread is executed as it is, there is a possibility that the output side FIFO memory is overflowed. To solve such a problem, it is necessary to restrict the processing by lowering the priority of the thread so that the output side FIFO memory is not overflowed. For this purpose, the priority of the thread is set to make it more difficult to execute the thread (the priority is lowered) as the amount of accumulation in the output side FIFO memory increases as shown in FIG. 40.

The thirteenth embodiment is different from the twelfth embodiment in that a different thread execution priority is set between the period during which the amounts of accumulation of the FIFO memories increase and the period during which they decrease. Even if the FIFO memory have the same amount of accumulation, the priority of a thread at a point of intersection 701 at which the amount of data accumulated by the FIFO memory increases, for example, is higher than that of the thread at a point of intersection 702 at which the amount of data accumulated by the FIFO memory decreases.

When the relationship between the amount of data accumulated by the output side FIFO memory and the processing of a thread is considered, there is a tendency that when the thread is executed, the amount of data accumulated by the output side FIFO memory is increased, whereas when the thread is not executed, it is decreased. At this time, when the increase of the amount of data accumulated by the FIFO memory including the point of intersection of 702 is considered, even if the amount of data accumulated by the output side FIFO memory is increased, the priority of the thread is moderately lowered. On the contrary, when the decrease of the amount of data accumulated by the FIFO memory including the point of intersection 701 is considered, even if the amount of data accumulated by the output side FIFO memory is decreased, the priority of the thread is moderately increased. That is, even if the amount of data accumulated by the output side FIFO memory is changed, there is a great possibility that the thread whose processing is started once is continuously executed because the priority thereof is maintained at a high level. On the contrary, this means that when the priority of a thread is lowered and thus the execution of the thread becomes difficult, it is difficult to execute the thread unless the amount of data accumulated by the output side FIFO memory is more lowered.

Therefore, by providing an output side FIFO memory having the characteristics of FIG. 40 likewise the input side FIFO memory having the characteristics of FIG. 39, it is possible to realize a state that a thread is liable to be executed frequently, thereby the overhead of the cache 104 when it reads data can be reduced.

Although the example of FIG. 40 shows the relationship between the amount of data accumulated by the FIFO memory and thread execution priority by an ellipse, it is not necessarily ellipse. For example, the priority may be set to increase stepwise so that it can be easily realized when the processor is designed.

As described above, the execution control unit 103 determines the priorities of the threads according to the priorities that are obtained by synthesizing both the priorities obtained from the input and output FIFO memories or according to the priorities based on the input side FIFO memories.

At this time, it is also contemplated that the priority obtained from the amount of data accumulated by the input side FIFO memories contradicts the priority obtained from the output side FIFO memory. This is, for example, a case that processing data is not accumulated in both the input side and output side FIFO memories. In this case, since a thread need not be preferentially executed, the priority determined based on the amount of data accumulated by the input side FIFO memory is preferentially employed.

In contrast, there can be contemplated a case that the amounts of accumulation of both the input and output FIFO memories are near to the upper limits thereof. In this case, the priority determined based on the amount of data accumulated by the input side FIFO memory is preferentially employed under the condition that the vacant region of the amount of data accumulated by the output side FIFO memories has a region in which a result of output, which is obtained after the processing data stored in the input side FIFO memory has been processed, can be stored. Except for the above case, the priority determined based on the amount of data accumulated by the output side FIFO memory is preferentially employed or the execution of the thread having the priority is temporarily prohibited to prevent the overflow of the output side FIFO memory.

A figure, which shows an example of a flow for determining a thread that will be executed next in the processor of the embodiment, is the same as that of FIG. 38 of the twelfth embodiment.

As described above, in the thirteenth embodiment, since the priorities of the threads are changed depending on whether the amounts of accumulated data of the input side and output side FIFO memories tend to increase or decrease, the overhead of the cache 104 when it reads data can be reduced.

In order to reduce the overhead for data read by the cache 104, the following method may be used. First, the priorities of all the threads are detected. Next, the amount of accumulated data on the input side FIFO memory and the amount of accumulated data on the output side FIFO memory of the thread whose priority is the highest, and a tendency on which the amounts change are checked.

After then t is determined whether or not the amount of accumulated data on the input side FIFO memory of the thread is in an increasing tendency, and the amount of accumulated data on the output side FIFO memory is in a decreasing tendency. In the case of satisfying either one, it is determined whether or not the amount of accumulated data of the output side FIFO memory is less than a first threshold value, or whether or not the amount of accumulated data of the input side FIFO memory is more than a second threshold value. When either condition is satisfied, start-up of the thread is restricted.

Note that the present invention is by no means limited to the above embodiments and may be embodied by modifying the components thereof within a range that does not depart from the gist of the invention. Other embodiments of the present invention will be apparent to those skilled in the art from consideration of the specification and practice of the invention disclosed herein. It is intended that the specification and example embodiments be considered as exemplary only, with a true scope and spirit of the invention being indicated by the following. Further, the components of different embodiments may be appropriately combined.

What is claimed is:

1. A processor which performs data processings including a plurality of execution units, comprising:
a storage which stores data used for processings of the execution units and processing results by the execution units, by each of the execution units;
a data processing part configured to acquire data of the execution units from said storage to perform the processings, and configured to output the processing results in said storage;
an execution unit judgement part configured to determine whether or not said storage holds data used for the processings of a certain execution unit, and whether or not said storage has a vacant region capable of storing the processing result of the certain execution unit; and
an execution unit determination part which determines an execution unit to be processed next among said plurality of execution units, based on a result judged by said execution unit judgement part.

2. The processor according to claim 1, wherein said storage includes:
a first storing part which stores data used for the processing of the execution unit prescribed in advance; and
a second storing part which stores the processing result obtained by performing the processings of the corresponding execution unit by using data acquired from said first storage, and stores data used by an other execution unit using the processing result by the corresponding execution unit,
wherein said execution unit judgement part judges whether or not said first storing part holds data used for the processing of the execution unit, and whether or not said second storage part has the vacant region storing the processing result of the execution unit.

3. The processor according to claim 2, further comprising a priority setting part configured to set priorities to said plurality of execution units,
wherein said execution unit determination unit determines the execution unit to be started up, based on the priorities set by said priority setting unit.

4. The processor according to claim 3, further comprising a start-up frequency measuring part configured to measure start-up frequencies of said plurality of execution units,
wherein said priority setting part sets the priorities based on the start-up frequency measured by said start-up frequency measuring part.

5. The processor according to claim 3, wherein when a first execution unit is being started up, said execution unit determination part holds data used for a second execution unit with a priority higher than said first execution unit, and suspends operation of said first execution unit to start up said second execution unit when said second storage has the vacant region to store the processing result by said second execution unit.

6. The processor according to claim 2, wherein said data processing part includes:
a register set group which has a plurality of register sets including all of information inherent to the execution units;
a register set selector which selects the register set used by the execution units determined by said execution unit determination part; and
an operation processing part configured to perform processing of the execution unit decided by said execution unit determination part by using the register set selected by said register set selector.

7. The processor according to claim 2, further comprising:
a register set group which has a plurality of register sets including all of information inherent to the execution units;
a register selector which selects the register set used by the execution unit determined by said execution unit determination part;
an operation processing part configured to perform processing of the execution units determined by said execution unit determination part by using the register set selected by said register set selector;
an external register set storage capable of storing contents of an arbitrary register set included in said register set group; and
a storage controller which transfers contents of the register set used by the other execution unit under suspension or to be suspended, included in the register set group, to said external register set storage, when contents of the register set used by the execution unit is stored in said external register set storage, and transfers data from said external register set storage to the register set.

8. The processor according to claim 7, further comprising a hit determination part configured to determine whether or not the execution unit determined by said execution unit determination part exists in the register set group,
wherein said register set selector selects the register set from said register set group when said hit determination part determines that the register set used by the execution unit exists in said register set group, and selects the register set which holds data transferred from said external register set storage when said hit determination part determines that the register set does not exist in said register set group.

9. The processor according to claim 8, further comprising a retreating register set determination part configured to select the register set to retreat into said external register set storage from said register set group when said hit determination part determines that the register set does not exist in said register set group,
wherein said storage controller transfers contents of the register set selected by said retreating register set determination part to said external register set storage.

10. The processor according to claim 6, wherein said execution unit determination part determines the execution unit by taking into consideration the judgement result by said execution unit judgement part, and even when said storage controller is performing an exchanging processing of the register sets between said register set group and said external register set storage, determines the execution unit capable of executing the processings without being influenced on the exchanging processing.

11. The processor according to claim 6, wherein said storage controller transfers only a value of the register changed among said register set group, to said external register set storage when there is a necessity to update contents stored in said external register set storage.

12. The processor according to claim 6, wherein said storage controller transfers only contents of the registers changed by executing an other execution unit from said external register set storage to said register set group, when it is necessary to transfer data from said external register set storage to said register set group.

13. The processor according to claim 6, wherein said storage controller transfers contents of the register set to said external register set storage as far as the same register set as the register set stored in said external register set storage does not exist in said register set group.

14. An arithmetic operation processing method, comprising:
executing processings by each of execution units which executes time-sharing processings for a certain data processing;
storing data used by processing for the execution unit prescribed in advance into a first storage;
storing the processing result obtained by processing of the corresponding execution unit by using data acquired from said first storage into a second storage, and storing data used by processings of an other execution unit using the stored processing result by the corresponding execution unit;
judging whether or not said first storage holds data using to the processings of the execution unit, and whether or not said second storage has a vacant region to store the processing result of the execution unit; and
determining the execution unit to be started up next among said plurality of execution units.

15. A processor, comprising:
a data processing part configured to execute processings by each of execution units which execute time-sharing processings for a certain data processing;
a plurality of storages which stores data used by the execution unit to be executed by said data processing part, or an execution result of data used by the execution unit to be executed by said data processing part; and
a priority determination part configured to determine priorities of the execution units using data stored in the storages based on the amount of data stored in said plurality of storages.

16. The processor according to claim 15, wherein said priority determination part determines a higher priority for the execution unit receiving data to be processed from said storage, as the amount of data stored by a certain storage is larger.

17. The processor according to claim 15, wherein said priority determination part determines a lower priority for the execution unit storing the execution result in said storage, as the amount of data stored by a certain storage is larger.

18. The processor according to claim 16, wherein as compared a first case where the amount of data stored in the storage receiving data to be processed by a certain execution unit is in an increasing tendency with a second case where data stored in the storage receiving data to be processed by the certain execution unit is in a decreasing tendency, even if the amount of data stored in said storage in said first case is equal to the amount of data stored in said storage in said second case, the priority of the execution unit receiving data to be processed from said storage in said second case is set higher than that of the execution unit in said first case.

19. The processor according to claim 17, wherein as compared a first case where the amount of data stored in the storage storing the execution result by a certain execution unit is in an increasing tendency with a second case where the amount of data stored in the storage storing the execution result by the certain execution unit is an decreasing tendency, even if the amount of data stored in said storage in said first case is equal to the amount of data stored in said storage in said second case, the priority of the execution unit storing the execution result in the storage in said first case is set higher than that of the execution unit in the second case.

20. The processor according to claim 15, wherein said priority determination part sets the highest priority for the execution unit which receives data to be processed from a certain storage when determined that the data amount stored by said certain storage exceeds a limit of memory capacity of said certain storage.

21. The processor according to claim 15, wherein said priority determination unit sets the lowest priority for the execution unit which receives data to be processed from a certain storage when determined that the data amount stored by said certain storage exceeds a limit of memory capacity of said certain storage.

22. A priority determination method, comprising:
executing processing by each of execution units which executes time-sharing processings for a certain data processing;
storing data used by an execution unit to be executed or an execution result by the execution unit, into a plurality of storages; and
determining a priority of the execution unit using data stored in said storages based on the data amount stored in said plurality storages.

23. The processor according to claim 16, wherein the execution units include a first execution unit and a second execution unit,
wherein the plurality of storages include a first storage to store data used by the first execution unit and a second storage to store data used by the second execution unit,
wherein the priority determination part sets the priority of the first execution unit lower than the second execution unit, if the following conditions are fulfilled:
(a) the amount of data of the first storage is equal to that of the second storage;
(b) the amount of data of the first storage is increasing tendency; and
(c) the amount of data of the second storage is decreasing tendency.

24. The processor according to claim 17, wherein the execution units include a first execution unit and a second execution unit,
wherein the plurality of storages include a first storage to store the execution result of the first execution unit and a second storage to store the execution result of the second execution unit,
wherein the priority determination part sets the priority of the first execution unit higher than the second execution unit, if the following conditions are fulfilled:
(a) the amount of data of the first storage is equal to that of the second storage;
(b) the amount of data of the first storage is increasing tendency; and
(c) the amount of data of the second storage is decreasing tendency.
